(19) United States
(12) Patent Application Publication
(10) Pub. No.: US 2012/0229677 A1
(43) Pub. Date: Sep. 13, 2012

(54) IMAGE GENERATOR, IMAGE GENERATING METHOD, AND COMPUTER PROGRAM

(75) Inventors: Sanzo UGAWA, Osaka (JP); Takeo AZUMA, Kyoto (JP); Taro IMAGAWA, Osaka (JP); Yusuke OKADA, Osaka (JP)

(73) Assignee: PANASONIC CORPORATION, Osaka (JP)

(21) Appl. No.: 13/477,220

(22) Filed: May 22, 2012

Related U.S. Application Data
(63) Continuation of application No. PCT/JP2011/003975, filed on Jul. 12, 2011.

(30) Foreign Application Priority Data
Jul. 12, 2010 (JP) 2010-157616

(51) Int. Cl. H04N 9/64; H04N 9/77

(52) U.S. Cl. 348/234; 348/242; 348/E09.037; 348/E09.035

(57) ABSTRACT

An exemplary image generator includes: an image quality improvement processing section configured to receive signals representing first, second, and third moving pictures, obtained by shooting the same subject, and configured to generate a new moving picture representing that subject; and an output terminal that outputs a signal representing the new moving picture. The second moving picture has a different color component from the first moving picture and each frame of the second moving picture has been obtained by performing an exposure process for a longer time than one frame period of the first moving picture. The third moving picture has the same color component as the second moving picture and each frame of the third moving picture has been obtained by performing an exposure process for a shorter time than one frame period of the second moving picture.

This is a continuation of International Application No. PCT/JP2011/003975, with an international filing date of Jul. 12, 2011, which claims priority of Japanese Patent Application No. 2010-157616, filed on Jul. 12, 2010, the contents of which are hereby incorporated by reference.

### BACKGROUND

1. Technical Field

The present application relates to image processing to be carried out on a moving picture, and more particularly relates to a technique for generating a moving picture of which the resolution and/or frame rate has/have been increased by subjecting the picture shot to image processing.

2. Description of the Related Art

In conventional imaging processors, the more significantly the pixel size of an imager is reduced in order to increase the resolution, the smaller the amount of light falling on each pixel of the imager. As a result, the signal to noise ratio (SNR) of each pixel will decrease too much to maintain good enough image quality.

According to Japanese Laid-Open Patent Publication No. 2009-105992, by using three imagers and by processing respective signals to be obtained with the exposure time controlled, a moving picture with high resolution and frame rate is restored. Specifically, according to that method, imagers with two different levels of resolutions are used, one of the two imagers with the higher resolution reads a pixel signal through a longer exposure process, and the other imager with the lower resolution reads a pixel signal through a shorter exposure process, thereby getting as much amount of light as possible.

### SUMMARY

The conventional art technique needs further improvement in view of the image quality.

One non-limiting and exemplary embodiment provides a technique to generate a moving picture with a sufficient amount of light used and with such color smearing minimized. Another non-limiting and exemplary embodiment provides to restore a moving picture at a high frame rate and a high resolution at the same time.

One non-limiting and exemplary embodiment of the present disclosure provides an image generator including: an image quality improvement processing section that receives signals representing first, second, and third moving pictures, which have been obtained by shooting the same subject, and that generates a new moving picture representing that subject; and an output terminal that outputs a signal representing the new moving picture. The second moving picture has a different color component from the first moving picture and each frame of the second moving picture has been obtained by performing an exposure process for a longer time than one frame period of the first moving picture. And the third moving picture has the same color component as the second moving picture and each frame of the third moving picture has been obtained by performing an exposure process for a shorter time than one frame period of the second moving picture.

The general and specific embodiments described herein are intended to be non-limiting and may be implemented using a system, a method, and a computer program, and any combination of systems, methods, and computer programs.

Additional benefits and advantages of the disclosed embodiments will be apparent from the specification and Figures. The benefits and/or advantages should not be construed as limiting and may be individually provided by the various embodiments and features of the specification and drawings disclosure, and need not all be provided in order to obtain one or more of the same.

### BRIEF DESCRIPTION OF DRAWINGS

FIG. 1 is a block diagram illustrating a configuration for an image capturing processor 100 as a first embodiment of the present disclosure.

FIG. 2 illustrates an exemplary detailed configuration for the image quality improving section 105.

FIGS. 3A and 3B respectively illustrate a base frame and a reference frame for use to detect a motion by block matching.

FIGS. 4A and 4B show virtual sample points in a situation where spatial addition is performed on 2×2 pixels.

FIG. 5 shows the timings to read pixel signals that are associated with G_{L}, G_{S}, R and B.

FIG. 6 illustrates an exemplary configuration for an image quality improvement processing section 202 according to the first embodiment.

FIG. 7 illustrates an exemplary correspondence between the RGB color space and the spherical coordinate system (θ, ψ, r).

FIG. 8 illustrates diagrammatically what input and output moving pictures are like in the processing of the first embodiment.

FIG. 9 shows what PSNR values are obtained by a single imager in a situation where every G pixel is subjected to an exposure process for a long time and in a situation where it is processed by the method proposed for the first embodiment.

FIG. 10 shows three frames of a moving picture that was used in a comparative experiment.

FIG. 11 shows three frames of another moving picture that was used in the comparative experiment.

FIG. 12 shows three frames of another moving picture that was used in the comparative experiment.

FIG. 13 shows three frames of another moving picture that was used in the comparative experiment.

FIG. 14 shows three frames of another moving picture that was used in the comparative experiment.

FIG. 15 shows three frames of another moving picture that was used in the comparative experiment.

FIG. 16 shows how the compression rate δ for encoding needs to be changed according to the degree of reliability γ of the moving picture generated.

FIG. 17 illustrates a configuration for an image capturing processor 500 according to a second embodiment of the present disclosure.

FIG. 18 illustrates a detailed configuration for the image quality improvement processing section 202 according to the second embodiment.

FIG. 19 illustrates a configuration for the G simplified restoration section 1901.

FIGS. 20A and 20B illustrate how G_{S} and G_{L} calculating sections 2001 and 2002 may perform their processing.

FIG. 21 illustrates a configuration in which a Bayer restoration section 2201 is added to the image quality improvement processing section 202 of the first embodiment.

FIG. 22 illustrates an exemplary arrangement of color filters in a Bayer arrangement.

FIG. 23 illustrates a configuration in which the Bayer restoration section 2201 is added to the image quality improvement processing section 202 of the second embodiment.

FIG. 24 illustrates a configuration for an image capturing processor 300 according to a fourth embodiment of the present disclosure.

FIG. 25 illustrates a configuration for the control section 107 of the fourth embodiment.

FIG. 26 illustrates a configuration for the control section 107 of an image capturing processor according to a fifth embodiment of the present disclosure.

FIG. 27 illustrates a configuration for the control section 107 of an image capturing processor according to a sixth embodiment of the present disclosure.

FIG. 28 illustrates a configuration for the control section 107 of an image capturing processor according to a seventh embodiment of the present disclosure.

FIGS. 29(a) and 29(b) illustrate an example in which a single imager is combined with color filters.

FIGS. 30(a) and 30(b) each illustrate a configuration for an imager that generates G (i.e., G_{L} and G_{S}) pixel signals.

FIGS. 31(a) and 31(b) each illustrate a configuration for an imager that generates G (i.e., G_{L} and G_{S}) pixel signals.

FIG. 32(a) through 32(c) illustrate exemplary arrangements in which G_{S} color filters are included in each set consisting mostly of R and B color filters.

FIG. 33A shows the spectral characteristics of thin-film optical filters for three imagers.

FIG. 33B shows the spectral characteristic of a dye filter for a single imager.

FIG. 34A shows the timings of an exposure process that uses a global shutter.

FIG. 34B shows the timings of an exposure process when a focal plane phenomenon happens.

FIG. 35 is a block diagram illustrating a configuration for an image capturing processor 500 that includes an image processing section 105 with no motion detecting section 201.

FIG. 36 is a flowchart showing the procedure of image quality improvement processing to be carried out by the image quality improving section 105.

### DETAILED DESCRIPTION

Assume that imagers with two different levels of resolutions are used. If a pixel signal with the higher resolution is read through the longer exposure process and if the subject is moving, then the resultant image will be a shaky one. That is why even though the image quality of the moving picture thus obtained is generally high, the moving picture generated will sometimes have color smearing in some ranges where it is difficult to get motion detection done perfectly. Thus, there is still room for improvement left according to such a technique.

In a non-limiting exemplary embodiment of the present disclosure, an image generator includes: an image quality improvement processing section that receives signals representing first, second, and third moving pictures, which have been obtained by shooting the same subject, and that generates a new moving picture representing that subject; and an output terminal that outputs a signal representing the new moving picture. The second moving picture has a different color component from the first moving picture and each frame of the second moving picture has been obtained by performing an exposure process for a longer time than one frame period of the first moving picture. And the third moving picture has the same color component as the second moving picture and each frame of the third moving picture has been obtained by performing an exposure process for a shorter time than one frame period of the second moving picture.

By using signals representing the first, second and third moving pictures, the image quality improvement processing section may generate a new moving picture, of which the frame rate is equal to or higher than the frame rate of the first or third moving picture and the resolution is equal to or higher than the resolution of the second or third moving picture.

The second moving picture may have a higher resolution than the third moving picture. By using signals representing the second and third moving pictures, the image quality improvement processing section may generate, as one of the color components of the new moving picture, a signal representing a moving picture, of which the resolution is equal to or higher than the resolution of the second moving picture, the frame rate is equal to or higher than the frame rate of the third moving picture and the color component is the same as the color component of the second and third moving pictures.

The image quality improvement processing section may determine the pixel value of each frame of the new moving picture so as to reduce a difference in the pixel value of each frame between the second moving picture and the new moving picture being subjected to temporal sampling so as to have the same frame rate as the second moving picture.

The image quality improvement processing section may generate a moving picture signal with a color green component as one of the color components of the new moving picture.

The image quality improvement processing section may determine the pixel value of each frame of the new moving picture so as to reduce a difference in the pixel value of each frame between the first moving picture and the new moving picture being subjected to spatial sampling so as to have the same resolution as the first moving picture.

Frames of the second and third moving pictures may be obtained by performing an open exposure between the frames.

The image quality improvement processing section may specify a constraint, which the value of a pixel of the new moving picture to generate needs to satisfy in order ensure continuity with the values of pixels that are temporally and spatially adjacent to the former pixel, and may generate the new moving picture so as to maintain the constraint specified.

The image generator may further include a motion detecting section that detects the motion of an object based on at least one of the first and third moving pictures. The image quality improvement processing section may generate the new moving picture so that the value of each pixel of the new moving picture to generate maintains the constraint to be satisfied based on a result of the motion detection.

The motion detection section may calculate the degree of reliability of the motion detection. And the image quality improvement processing section may generate a new picture by applying a constraint based on a result of the motion detection to an image area, of which the degree of reliability calculated by the motion detection section is high and by applying a predetermined constraint, other than the motion constraint, to an image area, of which the degree of reliability is low.

The motion detection section may detect the motion on the basis of a block, which is defined by dividing each of multiple images that form the moving picture, may calculate the sum of squared differences between the pixel values of those blocks and may obtain the degree of reliability by inverting the sign of the sum of squared differences. The image quality improvement processing section may generate the new moving picture with a block, of which the degree of reliability is greater than a predetermined value, defined to be an image area with a high degree of reliability and with a block, of which the degree of reliability is smaller than the predetermined value, defined to be an image area with a low degree of reliability.

The motion detection section may include an orientation sensor input section that receives a signal from an orientation sensor that senses the orientation of an image capture device that captures an object, and may detect the motion based on the signal that has been received by the orientation sensor input section.

The image quality improvement processing section may extract color difference information from the first and third moving pictures, may generate an intermediate moving picture based on the second moving picture and luminance information obtained from the first and third moving pictures, and then may add the color difference information to the intermediate moving picture thus generated, thereby generating the new moving picture.

The image quality improvement processing section may calculate the magnitude of temporal variation of the image with respect to at least one of the first, second and third moving pictures. If the magnitude of variation calculated is going to exceed a predetermined value, the image quality improvement processing section may stop generating the moving picture based on images that have been provided until just before the predetermined value is exceeded, and may start generating a new moving picture right after the predetermined value has been exceeded.

The image quality improvement processing section may further calculate a value indicating the degree of reliability of the new moving picture generated and may output that calculated value along with the new moving picture.

The image generator may further include an image capturing section that generates the first, second and third moving pictures using a single imager.

The image generator may further include a control section that controls the processing by the image quality improvement processing section according to a shooting environment.

The image capturing section may generate the second moving picture, which has a higher resolution than the third moving picture, by performing a spatial pixel addition. The control section may include a light amount detecting section that detects the amount of light that has been sensed by the image capturing section. And if the amount of light that has been detected by the light amount detecting section is equal to or greater than a predetermined value, the control section may change an exposure time and/or the magnitude of the spatial pixel addition with respect to at least one of the first, second and third moving pictures.

The control section may include a level detecting section that detects the level of a power source for the image generator, and may change an exposure time and/or the magnitude of the spatial pixel addition with respect to at least one of the first, second and third moving pictures according to the level that has been detected by the level detecting section.

The control section may include a magnitude of motion detecting section that detects the magnitude of motion of the subject, and may change an exposure time and/or the magnitude of the spatial pixel addition with respect to at least one of the first, second and third moving pictures according to the magnitude of motion of the subject that has been detected by the magnitude of motion detecting section.

The control section may include a mode of processing choosing section that allows the user to choose a mode of making image processing computations, and may change an exposure time and/or the magnitude of the spatial pixel addition with respect to at least one of the first, second and third moving pictures according to the mode chosen through the mode of processing choosing section.

The image quality improvement processing section may specify a constraint, which the value of a pixel of the new moving picture to generate needs to satisfy in order ensure continuity with the values of pixels that are temporally and spatially adjacent to the former pixel and may generate the new moving picture so as to reduce a difference in the pixel value of each frame between the second moving picture and the new moving picture being subjected to temporal sampling so as to have the same frame rate as the second moving picture and so as to maintain the constraint that has been specified.

The image generator may further include an image capturing section that generates the first, second and third moving pictures using three imagers.

In a non-limiting exemplary embodiment of the present disclosure, an image generating method includes the steps of: receiving signals representing first, second, and third moving pictures, which have been obtained by shooting the same subject, the second moving picture having a different color component from the first moving picture, each frame of the second moving picture having been obtained by performing an exposure process for a longer time than one frame period of the first moving picture, the third moving picture having the same color component as the second moving picture, each frame of the third moving picture having been obtained by performing an exposure process for a shorter time than one frame period of the second moving picture; generating a new moving picture representing that subject based on the first, second and third moving pictures; and outputting a signal representing the new moving picture.

In a non-limiting exemplary embodiment of the present disclosure, a computer program is defined to generate a new moving picture based on multiple moving pictures, and makes a computer, which executes the computer program, perform the steps of the image generating method of the present disclosure described above.

According to the present disclosure, the pixels of a color component image that has been read through an exposure process for a long time (e.g., G pixels) are classified into two kinds of pixels—pixels to be subjected to an exposure process for a long time and pixels to be subjected to an exposure process for a short time and an intra-frame pixel addition, and signals are read from those two kinds of pixels. In that case, since at least the latter kind of pixels to be subjected to the intra-frame pixel addition are subjected to an exposure process for a short time, an image signal can be obtained with that color smearing due to the subject's motion reduced compared to a situation where the entire image signal is obtained through an exposure process for a long time.

By obtaining a single color component image using those two kinds of pixels, a high-frame-rate and high-resolution moving picture can be restored with a good number of pixels (i.e., a sufficiently high resolution) and plenty of light sensed (i.e., a sufficiently high brightness) ensured for that color component image.

Hereinafter, embodiments of an image generator according to the present disclosure will be described with reference to the accompanying drawings.

### Embodiment 1

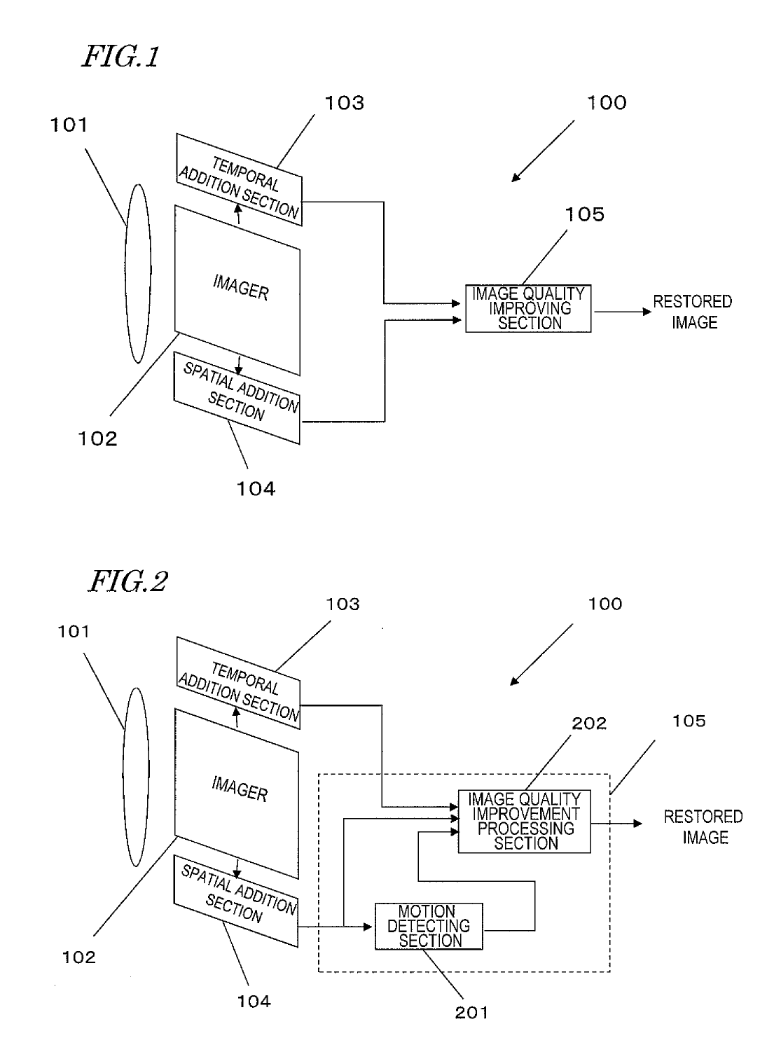

FIG. 1 is a block diagram illustrating a configuration for an image capturing processor 100 as a first specific embodiment of the present disclosure. As Shown in FIG. 1, the image capturing processor 100 includes an optical system 101, a single color imager 102, a temporal addition section 103, a spatial addition section 104, and an image quality improving section 105. Hereinafter, these components of this image capturing processor 100 will be described in detail.

The optical system 101 may be a camera lens, for example, and produces a subject's image on the image surface of the imager.

The single color imager 102 is a single imager to which a color filter array is attached. The single color imager 102 photoelectrically converts the light that has been imaged by the optical system 101 (i.e., an optical image) into an electrical signal and outputs the signal thus obtained. The values of this electrical signal are the respective pixel values of the single color imager 102. That is to say, the single color imager 102 outputs pixel values representing the amounts of the light that has been incident on those pixels. The pixel values of a single color component that have been obtained at the same frame time form an image representing that color component. And a color image is obtained by combining multiple images representing all color components.

The temporal addition section 103 subjects the photoelectrically converted values of a part of a first color component of the color image that has been captured by the single color imager 102 to a multi-frame addition in the temporal direction.

In this description, the “addition in the temporal direction” refers herein to adding together the respective pixel values of pixels that have the same set of pixel coordinates in a series of frames (or pictures). Specifically, the pixel values of pixels that have the same set of pixel coordinates in about two to nine frames are added together.

The spatial addition section 104 adds together, in the spatial direction, the photoelectrically converted values of multiple pixels of a part of the first color component and all of the second and third color components of the color moving picture that has been captured by the single color imager 102.

In this description, the “addition in the spatial direction” refers herein to adding together the respective pixel values of multiple pixels that form one frame (or picture) that has been shot at a certain point in time. Specifically, examples of the “multiple pixels”, of which the pixel values are to be added together, include two horizontal pixels×one vertical pixel, one horizontal pixel×two vertical pixels, two horizontal pixels×two vertical pixels, two horizontal pixels×three vertical pixels, three horizontal pixels×two vertical pixels, and three horizontal pixels×three vertical pixels. The pixel values (i.e., the photoelectrically converted values) of these multiple pixels are added together in the spatial direction.

The image quality improving section 105 receives not only the data of that part of the first-color moving picture that has been subjected to the temporal addition by the temporal addition section 103 but also the data of that part of the first-color moving picture and all of the second- and third-color moving pictures that have been subjected to the spatial addition by the spatial addition section 104, and subjects them to image restoration, thereby estimating the first, second and third color values of each pixel and restoring a color moving picture.

FIG. 2 illustrates an exemplary detailed configuration for the image quality improving section 105. Other than the image quality improving section 105, however, the configuration shown in FIG. 2 is the same as what is shown in FIG. 1. The image quality improving section 105 includes a motion detection section 201 and an image quality improvement processing section 202.

The motion detection section 201 detects a motion (as an optical flow) from that part of the first-color moving picture and the second- and third-color moving pictures that have been spatially added by using known techniques such as block matching, gradient method, and phase correlation method. The known techniques are disclosed by P. ANANDAN in “A Computational Framework and an algorithm for the measurement of visual motion”, International Journal of Computer Vision, Vol. 2, pp. 283-310, 1989, for example.

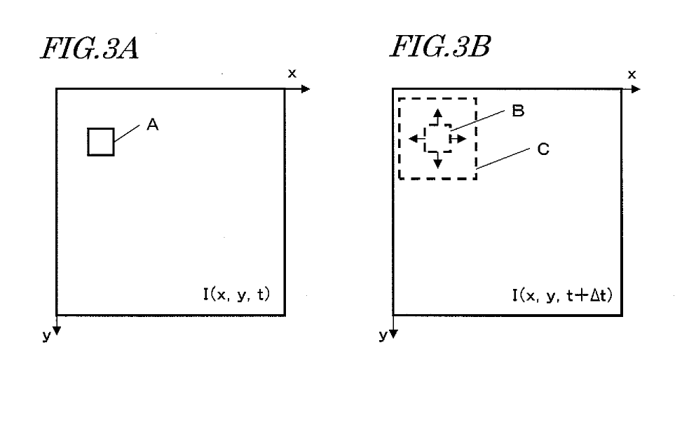

FIGS. 3A and 3B respectively illustrate a base frame and a reference frame for use to detect a motion by block matching. Specifically, the motion detection section 201 sets a window area A shown in FIG. 3A in the base frame (i.e., a picture in question at a time t, from which the motion needs to be detected), and then searches the reference frame for a pattern that is similar to the pattern inside the window area. As the reference frame, the frame that follows the target frame is often used.

The search range is usually defined to be a predetermined range (which is identified by C in FIG. 3B) with respect to a point B, at which the magnitude of motion is zero. Also, the degree of similarity between the patterns is estimated by calculating, as an estimate, either the sum of squared differences (SSD) represented by the following Equation (1) or the sum of absolute differences (SAD) represented by the following Equation (2):

$$\begin{matrix}SSD = {\sum }_{x , y ∈ W} {( f ( x + u , y + v , t + Δ t ) - f ( x , y , t ) )}^{2} & ( 1 ) \\ SAD = {\sum }_{x , y ∈ W} \vert f ( x + u , y + v , t + Δ t ) - f ( x , y , t ) \vert & ( 2 )\end{matrix}$$

In Equations (1) and (2) f (x, y, t) represents the temporal or spatial distribution of images (i.e., pixel values) and x, yε means the coordinates of pixels that fall within the window area in the base frame.

The motion detecting section 201 changes (u, v) within the search range, thereby searching for a set of (u, v) coordinates that minimizes the estimate value and defining the (u, v) coordinates to be a motion vector between the frames. And by sequentially shifting the positions of the window areas set, the motion is detected either on a pixel-by-pixel basis or on the basis of a block (which may consist of 8 pixels×8 pixels, for example), thereby generating a motion vector.

At this point in time, the motion detecting section 201 also obtains the temporal and spatial distribution conf (x, y, t) of the degrees of reliability of motion detection. In this description, the “degree of reliability of motion detection” is defined so that the higher the degree of reliability, the more likely the result of motion detection and that if the degree of reliability is low, then the result of motion detection should be erroneous. It should be noted that when the degree of reliability is said to be “high” or “low”, it means herein that the degree of reliability is either higher or lower than a predetermined reference value.

Examples of the methods for getting a motion between two adjacent frame images detected at each location on the image by the motion detecting section 201 include the method adopted by P. ANANDAN in “A Computational Framework and an algorithm for the measurement of visual motion”, International Journal of Computer Vision, Vol. 2, pp. 283-310, 1989, the motion detection method that is generally used in encoding a moving picture, and a feature point tracking method for use in tracking a moving object using images. Alternatively, by employing either a general method for detecting the global motion (such as the affine motion) of the entire image or the method disclosed by Lihi Zelnik-Manor in “Multi-body Segmentation: Revisiting Motion Consistency”, ECCV (2002), pp. 1-12, the motion may also be detected on a multiple-areas-at-a-time basis and used as the motion at each pixel location.

As the method for determining the degree of reliability, the method disclosed by P. Anandan in the document cited above may be used. Or if the motion is detected by the block matching method, the value obtained by subtracting the sum of squared differences between the pixel values of two blocks representing the motion from the maximum value SSDₘₐₓ of the sum of squared differences, i.e., the sum of squared differences between the pixel values of two blocks, may have its sign inverted and the value Conf (x, y, t) thus obtained may be used as the degree of reliability. Also, even when the global motion detection of the image or the area-by-area motion detection is adopted, the value conf (x, y, t) obtained by subtracting the sum of squared differences between the pixel value in an area near the starting point of motion from each pixel location and the pixel value in an area near the end point of that motion from the maximum value SSDₘₐₓ of the sum of squared differences may be used as the degree of reliability.

$$Conf ( x , y , z ) = {SSD}_{max} - {\sum }_{x , y ∈ W} {\{ I ( x + u , y + v , t + Δ t ) - I ( x , y , t ) \}}^{2} \qquad ( 3 )$$

block-by-block basis as described above, then the motion detecting section 201 may generate a new moving picture by defining a block, of which the degree of reliability is greater than a predetermined value, as a highly reliable image area and a block, of which the degree of reliability is smaller than the predetermined value, as an unreliable image area.

Alternatively, information provided by an orientation sensor that senses any change of the orientation of the shooting device may also be used as an input. In that case, the motion detecting section 201 includes an acceleration or angular velocity sensor and obtains either a velocity or an angular velocity as the integral of the acceleration. Or the motion detecting section 201 may further include an orientation sensor input section that receives information provided by the orientation sensor. In that case, by reference to the information provided by the orientation sensor, the motion detecting section 201 can obtain information about the overall motion of the image that has been set up by some change of the camera's orientation due to a camera shake, for example.

For example, by providing horizontal and vertical angular velocity sensors for the camera, horizontal and vertical accelerations can be obtained based on the outputs of those sensors as orientation values that are measured at each point in time. And by integrating the acceleration values with respect to time, the angular velocities at respective points in time can be calculated. If the camera has horizontal and vertical angular velocities ωₕ and ωᵥ at a point in time t, then the angular velocity of the camera can be associated uniquely with the two-dimensional motion (u, v) of the image at a point in time t and at a location (x, y) on the imager (or on the image) due to the orientation of the camera. The correlation between the camera's angular velocity and the motion of the image on the imager can be generally determined by the characteristics (including the focal length and the lens strain) of the camera's optical system, the relative arrangement of the imager and the pixel pitch of the imager. When calculating it actually, the correlation may be obtained by making geometric and optical calculations based on the characteristics of the optical system, the relative arrangement of the imager and the pixel pitch. Or the correlation may be stored in advance as a table and the image velocity (u, v) at a location (x, y) on the imager may be referred to based on the angular velocities ωₕ and ωᵥ of the camera.

The motion information that has been obtained using such sensors may also be used in combination with the result of motion detection obtained from the image. In that case, the sensor information may be used mostly in order to detect the overall motion of the image and the result of motion detection obtained from the image may be used in order to detect the motion of the object inside the image.

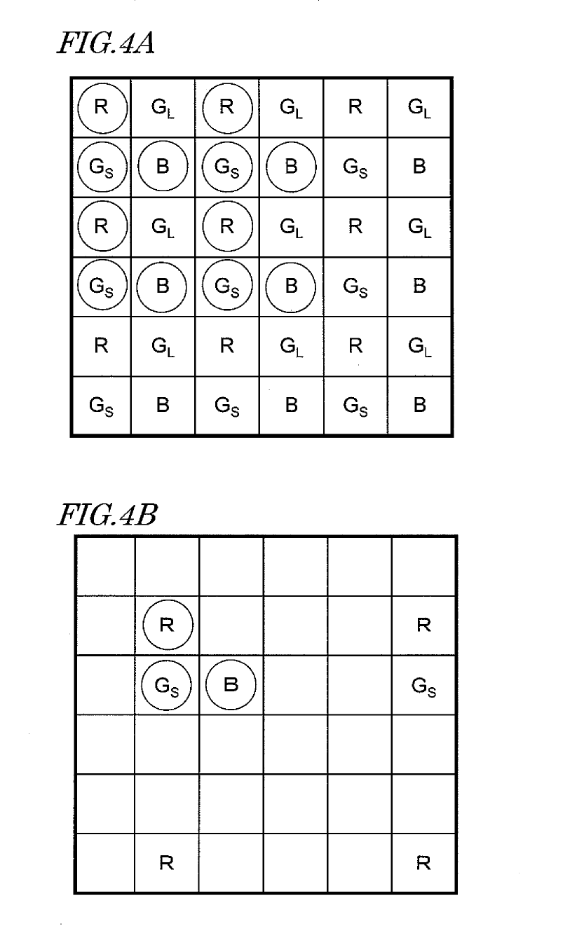

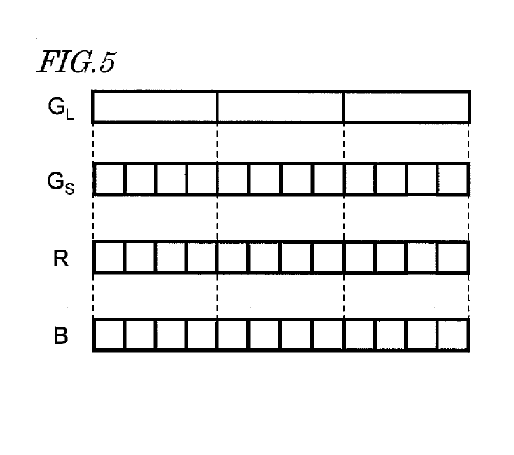

FIGS. 4A and 4B show virtual sample points in a situation where spatial addition is performed on 2×2 pixels. The respective pixels of the color imager get three color components of green (G), red (R) and blue (B). In this example, the color green (which will be simply referred to herein as “G”) is supposed to be a first color and the colors red and blue (which will be simply referred to herein as “R” and “B”) are supposed to be second and third colors, respectively.

Also, in the color green (G) component image, an image to be obtained by temporal addition will be identified herein by G_{L} and an image to be obtained by spatial addition will be identified herein by G. It should be noted, however, that when we say just R, G, B, G_{L} or G_{S}, it may refer to an image consisting of only components in that color.

FIG. 5 shows the timings to read pixel signals that are associated with G_{L}, G_{S}, R and B. G_{L} is obtained by performing temporal addition for four frames and G_{S}, R and B are obtained every frame.

FIG. 4B illustrates virtual sample points that are obtained by subjecting R and B shown in FIG. 4A to 2×2 pixel spatial addition. The respective pixel values of four pixels representing the same color are added together. And the pixel value thus obtained is regarded as the pixel value of the central one of the four pixels.

In that case, the virtual sample points are arranged at regular intervals (i.e., every four pixels) for only either R or B, but the interval between R and B is irregular at virtual sample points that have been set by spatial addition. That is why the (u, v) coordinates represented by either Equation (1) or (2) need to be changed every four pixels in this case. Alternatively, the R and B values of respective pixels may be obtained based on the R and B values of virtual sample points shown in FIG. 4B by a known interpolation method and then the (u, v) coordinates may be changed every other pixel.

By applying a linear function or a quadratic function to the distribution of (u, v) coordinates in the vicinity of the (u, v) coordinates thus obtained that minimize either Equation (1) or (2) (which is a known technique called “conformal fitting” or “parabolic fitting”), motion detection is carried out on a subpixel basis.

<How to Restore the G Pixel Value of Each Pixel>

The image quality improvement processing section 202 calculates the G pixel value of each pixel by minimizing the following Expression (4):

|H₁f−g_{L}|^{M}+|H₂f−g_{S}|^{M}+Q (4)

where H₁ represents the temporal sampling process, H₂ represents the spatial sampling process, f represents a G moving picture to be restored with a high spatial resolution and a high temporal resolution, g_{L} represents a G moving picture that has been captured by the image capturing section 101 and subjected to the temporal addition, g_{S} represents a G moving picture that has been captured by the image capturing section 101 and subjected to the spatial addition, M represents the exponent, and Q represents the condition to be satisfied by the moving picture f to be restored, i.e., a constraint.

Take the first term of Equation (4) as an example. The first term means calculating the difference between the g moving picture that has been obtained by sampling a G moving picture f to restore with a high spatial resolution and a high temporal resolution through the temporal sampling process H₁ and g_{L} that has been actually obtained through a temporal addition. If the temporal sampling process H₁ is defined in advance and if f that minimizes that difference is obtained, then it can be said that f will best match g_{L} that has been obtained through the temporal addition. The same can be said about the second term. That is to say, it can be said that f that minimizes the difference will best match g_{S} obtained through the spatial addition.

Furthermore, it can be said that f that minimizes Equation (4) will match well enough as a whole both g_{L} and g_{S} that have been obtained through the temporal and spatial addition processes, respectively. The image quality improvement processing section 202 calculates the pixel values of such a G moving picture with high spatial and temporal resolutions that minimizes Equation (4). It should be noted that the image quality improvement processing section 202 generates not only such a G moving picture with high spatial and temporal resolutions but also B and R moving pictures with a high spatial resolution as well. The process will be described in detail later.

Hereinafter, Equation (4) will be described in further detail.

f, g_{L} and g_{S} are column vectors, each of which consists of the respective pixel values of a moving picture. In the following description, a vector notation of a moving picture means a column vector in which pixel values are arranged in the order of raster scan. On the other hand, a function notation means the temporal or spatial distribution of pixel values. Because a pixel value is a intensity value, one pixel may has one pixel value. Supposing the moving picture to restore consists of 2000 horizontal pixels by 1000 vertical pixels in 30 frames, for example, the number of elements of f becomes 60000000 (=2000×1000×30).

If an image is captured by an imager with a Bayer arrangement such as the one shown in FIGS. 4A and 4B, the number of elements of g_{L} and g_{S} becomes 15000000, which is a quarter as large as that of f. The vertical and horizontal numbers of pixels of f and the number of frames for use to carry out signal processing are set by the image quality improving section 105. In the temporal sampling process H₁, f is sampled in the temporal direction. H₁ is a matrix, of which the number of rows is equal to the number of elements of g_{L} and the number of columns is equal to the number of elements of f. On the other hand, in the spatial sampling process H₂, f is sampled in the spatial direction. H₂ is a matrix, of which the number of rows is equal to the number of elements of g_{S} and the number of columns is equal to the number of elements of f.

Because the information about the number of pixels of a moving picture (which may consist of 200 horizontal pixels×1000 vertical pixels) and the number of frames (which may be 30 frames, for example) is too much amount for computers used extensively today, f that minimizes Equation (4) cannot be obtained through a single series of processing. In that case, by repeatedly performing the processing of obtaining f on temporal and spatial partial regions, the moving picture f to restore can be calculated.

Hereinafter, it will be described by way of a simple example how to formulate the temporal sampling process H₁. Specifically, it will be described how to capture G in a situation where an image consisting of two horizontal pixels (where x==1, 2) by two vertical pixels (where y==1, 2) in two frames (where t==1, 2) is captured by an imager with a Bayer arrangement and G_{L} is added for two frame periods.

f=(G₁₁₁G₂₁₁G₁₂₁G₂₂₁G₁₁₂G₂₁₂G₁₂₂G₂₂₂)^{T} (5)

H₁=(0 1 0 0 0 1 0 0) (6)

In this case, the sampling process H₁ is formulated as follows:

$$\begin{matrix}{g}_{L} = {H}_{1} f \\ = ( \begin{matrix}0 & 1 & 0 & 0 & 0 & 1 & 0 & 0\end{matrix} ) \\ {( \begin{matrix}{G}_{111} & {G}_{211} & {G}_{121} & {G}_{221} & {G}_{112} & {G}_{212} & {G}_{122} & {G}_{222}\end{matrix} )}^{T} \\ = {G}_{211} + {G}_{212}\end{matrix} \qquad ( 7 )$$

The number of pixels of g_{L} becomes one eighth of the total number of pixels that have been read in two frames.

Next, it will be described by way of a simple example how to formulate the spatial sampling process H₂. Specifically, it will be described how to capture G in a situation where an image consisting of four horizontal pixels (where x==1, 2, 3, 4) by four vertical pixels (where y==1, 2, 3, 4) in one frame (where t==1) is captured by an imager with a Bayer arrangement and four pixels of G_{S} are spatially added together.

f=(G¹¹¹G²¹¹G³¹¹G⁴¹¹G¹²¹G²²¹G³²¹G⁴²¹G¹³¹G²³¹G³³¹G⁴³¹G¹⁴¹G²⁴¹G³⁴¹G⁴⁴¹)^{T} (8)

H₂=(0 0 0 0 1 0 1 0 0 0 0 0 1 0 1 0) (9)

In this case, the sampling process H₂ is formulated as follows:

$$\begin{matrix}{g}_{S} = {H}_{2} f \\ = ( 0 \; 0 \; 0 \; 0 \; 1 \; 0 \; 1 \; 0 \; 0 \; 0 \; 0 \; 0 \; 1 \; 0 \; 1 \; 0 ) \times \\ ( {G}_{111} {G}_{211} {G}_{311 } {G}_{411} {G}_{121} {G}_{221} {G}_{321} {G}_{421} \\ { {G}_{131} {G}_{231} {G}_{331} {G}_{431} {G}_{141} {G}_{241} {G}_{341} {G}_{441} )}^{T} \\ = {G}_{121} + {G}_{321} + {G}_{141} + {G}_{441}\end{matrix} \qquad ( 10 )$$

The number of pixels of g_{S} becomes one sixteenth of the total number of pixels that have been read in one frame.

In Equations (5) and (8), G₁₁₁ through G₂₂₂ and G₁₁₁ through G₄₄₁ represent the G values of respective pixels and each of these three-digit subscripts indicates the x, y and z values in this order.

The value of the exponent M in Equation (4) is not particularly limited but is preferably one or two from the standpoint of computational load.

Equations (7) and (10) represent the process of obtaining g by temporally or spatially sampling f. Conversely, the problem of restoring f from g is generally called a “reverse problem”. If there are no constraints Q, there is an infinite number of f that minimizes the following Expression (11):

|H₁f−g_{L}|^{M}+|H₂f−g_{S}|^{M} (11)

This can be explained easily because this Expression (11) is satisfied even if an arbitrary value is substituted for a pixel value not to be sampled. That is why f cannot be solved uniquely just by minimizing Expression (11).

Thus, to obtain a unique solution with respect to f, a constraint Q is introduced. A smoothness constraint on the distribution of the pixel values f or a smoothness constraint on the distribution of motions of the moving picture derived from f is given as Q. In this description, the latter and former constraints will be sometimes referred to herein as a “motion-related constraint” and a “non-motion-related constraint”, respectively. It may be determined in advance in the image capturing processor 100 whether or not the motion-related constraint is used as the constraint Q and/or whether or not the non-motion-related constraint is used as the constraint Q.

The smoothness constraint on the distribution of the pixel values f may be given by any of the following constraint equations (12) and (13):

$$\begin{matrix}Q = {\vert \frac{\partial f}{\partial x} \vert}^{m} + {\vert \frac{\partial f}{\partial t} \vert}^{m} & ( 12 ) \\ Q = {\vert \frac{{\partial }^{2} f}{\partial {x}^{2}} \vert}^{m} + {\vert \frac{{\partial }^{2} f}{\partial {y}^{2}} \vert}^{m} & ( 13 )\end{matrix}$$

In the expressions, ∂f/∂x is a column vector whose elements are first-order differentiation values in the x direction of pixel values of the moving picture to be restored, ∂f/∂y is a column vector whose elements are first-order differentiation values in the y direction of pixels values of the moving picture to be restored, ∂²f/∂x² is a column vector whose elements are second-order differentiation values in the x direction of pixel values of the moving picture to be restored, and ∂²f/∂y² is a column vector whose elements are second-order differentiation values in the y direction of pixel values of the moving picture image to be restored. Moreover, ∥ represents the norm of a vector. The value of the exponent m is preferably 1 or 2, as is the exponent M in Expression 2 or Expression 7.

Note that the above partial differentiation values ∂f/∂x, ∂f/∂y, ∂²f/∂x² and ∂²f/∂y² can be approximately calculated by Expression 14, for example, through difference expansion using pixel values from around the target pixel.

$$\frac{\partial f ( x , y , t )}{\partial x} = \frac{f ( x + 1 , y , t ) - f ( x - 1 , y , t )}{2} \\ \frac{\partial f ( x , y , t )}{\partial y} = \frac{f ( x , y + 1 , t ) - f ( x , y - 1 , t )}{2} \\ \frac{{\partial }^{2} f ( x , y , t )}{\partial {x}^{2}} = f ( x + 1 , y , t ) - 2 f ( x , y , t ) + f ( x - 1 , y , t ) \\ \frac{{\partial }^{2} f ( x , y , t )}{\partial {y}^{2}} = f ( x , y + 1 , t ) - 2 f ( x , y , t ) + f ( x , y - 1 , t ) \qquad ( 14 )$$

The difference expansion is not limited to Expression 14 above, and other nearby pixels may be referenced as shown in Expression 15, for example.

$$\frac{\partial f ( x , y , t )}{\partial x} = \frac{1}{6} ( f ( x + 1 , y - 1 , t ) - f ( x - 1 , y - 1 , t ) + f ( x + 1 , y , t ) - f ( x - 1 , y , t ) + f ( x + 1 , y + 1 , t ) - f ( x - 1 , y + 1 , t ) ) \\ \frac{\partial f ( x , y , t )}{\partial y} = \frac{1}{6} ( f ( x - 1 , y + 1 , t ) - f ( x - 1 , y - 1 , t ) + f ( x , y + 1 , t ) - f ( x , y - 1 , t ) + f ( x + 1 , y + 1 , t ) - f ( x + 1 , y - 1 , t ) ) \\ \frac{{\partial }^{2} f ( x , y , t )}{\partial {x}^{2}} = \frac{1}{3} ( f ( x + 1 , y - 1 , t ) - 2 f ( x , y - 1 , t ) + f ( x - 1 , y - 1 , t ) + f ( x + 1 , y , t ) - 2 f ( x , y , t ) + f ( x - 1 , y , t ) + f ( x + 1 , y + 1 , t ) - 2 f ( x , y + 1 , t ) + f ( x - 1 , y + 1 , t ) ) \\ \frac{{\partial }^{2} f ( x , y , t )}{\partial {y}^{2}} = \frac{1}{3} ( f ( x - 1 , y + 1 , t ) - 2 f ( x - 1 , y , t ) + f ( x - 1 , y - 1 , t ) + f ( x , y + 1 , t ) - 2 f ( x , y , t ) + f ( x , y - 1 , t ) + f ( x + 1 , y + 1 , t ) - 2 f ( x + 1 , y , t ) + f ( x + 1 , y - 1 , t ) ) \qquad ( 15 )$$

Expression 15 obtains an average using values of a larger number of the peripheral pixels, as compared with the calculation value by Expression 14. This results in a lower spatial resolution, but is less susceptible to noise influence. Moreover, as something in-between, the following expression may be employed while weighting a within the range of

$$\frac{\partial f ( x , y , t )}{\partial x} = \frac{1 - α}{2} \frac{f ( x + 1 , y - 1 , t ) - f ( x - 1 , y - 1 , t )}{2} + α \frac{f ( x + 1 , y , t ) - f ( x - 1 , y , t )}{2} + \frac{1 - α}{2} \frac{f ( x + 1 , y + 1 , t ) - f ( x - 1 , y + 1 , t )}{2} \\ \frac{\partial f ( x , y , t )}{\partial y} = \frac{1 - α}{2} f ( x - 1 , y + 1 , t ) - f ( x - 1 , y - 1 , t ) + α \frac{f ( x , y + 1 , t ) - f ( x , y - 1 , t )}{2} + \frac{1 - α}{2} \frac{f ( x + 1 , y + 1 , t ) - f ( x + 1 , y - 1 , t )}{2} \\ \frac{{\partial }^{2} f ( x , y , t )}{\partial {x}^{2}} = \frac{1 - α}{2} ( f ( x + 1 , y - 1 , t ) - 2 f ( x , y - 1 , t ) + f ( x - 1 , y - 1 , t ) ) + α ( f ( x + 1 , y , t ) - 2 f ( x , y , t ) + f ( x - 1 , y , t ) ) + \frac{1 - α}{2} ( f ( x + 1 , y + 1 , t ) - 2 f ( x , y + 1 , t ) + f ( x - 1 , y + 1 , t ) ) \\ \frac{{\partial }^{2} f ( x , y , t )}{\partial {y}^{2}} = \frac{1 - α}{2} ( f ( x - 1 , y + 1 , t ) - 2 f ( x - 1 , y , t ) + f ( x - 1 , y - 1 , t ) ) + α ( f ( x , y + 1 , t ) - 2 f ( x , y , t ) + f ( x , y - 1 , t ) ) + \frac{1 - α}{2} ( f ( x + 1 , y + 1 , t ) - 2 f ( x + 1 , y , t ) + f ( x + 1 , y - 1 , t ) ) \qquad ( 16 )$$

As to how to expand the differences, α may be determined in advance according to the noise level so that the image quality will be improved as much as possible through the processing. Or to cut down the circuit scale or computational load as much as possible, Equation (14) may be used as well.

It should be noted that the smoothness constraint on the distribution of the pixel values of the moving picture f does not always have to be calculated by Equation (12) or (13) but may also be the m^{th} power of the absolute value of the second-order directional differential value given by the following Equation (17):

$$\begin{matrix}Q = {\vert \frac{\partial }{\partial {n}_{min}} ( \frac{\partial f}{\partial {n}_{min}} ) \vert}^{m} \\ = {\vert \frac{\partial }{\partial {n}_{min}} ( - sin θ \frac{\partial f}{\partial x} + cos θ \frac{\partial f}{\partial y} ) \vert}^{m} \\ = {\vert \begin{matrix}- sin θ \frac{\partial }{\partial x} ( - sin θ \frac{\partial f}{\partial x} + cos θ \frac{\partial f}{\partial y} ) + \\ cos θ \frac{\partial }{\partial y} ( - sin θ \frac{\partial f}{\partial x} + cos θ \frac{\partial f}{\partial y} )\end{matrix} \vert}^{m} \\ = \vert {sin}^{2} θ \frac{{\partial }^{2} f}{\partial {x}^{2}} - sin θ cos θ \frac{{\partial }^{2} f}{\partial x \partial y} - \\ { sin θcosθ \frac{{\partial }^{2} f}{\partial y \partial x} + {cos}^{2} \frac{{\partial }^{2} f}{\partial {y}^{2}} \vert}^{m}\end{matrix} \qquad ( 17 )$$

In Equation (17), the vector nₘᵢₙ and the angle θ indicate the direction in which the square of the first-order directional differential value becomes minimum and are given by the following Equation (18):

$$\begin{matrix}{n}_{min} = {( \begin{matrix}\frac{- \frac{\partial f}{\partial y}}{\sqrt{{( \frac{\partial f}{\partial x} )}^{2} + {( \frac{\partial f}{\partial y} )}^{2}}} & \frac{\frac{\partial f}{\partial x}}{\sqrt{{( \frac{\partial f}{\partial x} )}^{2} + {( \frac{\partial f}{\partial y} )}^{2}}}\end{matrix} )}^{T} \\ = {( \begin{matrix}- sin θ & cos θ\end{matrix} )}^{T}\end{matrix} \qquad ( 18 )$$

Furthermore, the smoothness constraint on the distribution of the pixel values of the moving picture f may also be changed adaptively to the gradient of the pixel value of f by using Q that is calculated by one of the following Equations (19), (20) and (21):

$$\begin{matrix}Q = w ( x , y ) \vert {( \frac{\partial f}{\partial x} )}^{2} + {( \frac{\partial f}{\partial y} )}^{2} \vert & ( 19 ) \\ Q = w ( x , y ) \vert {( \frac{{\partial }^{2} f}{\partial {x}^{2}} )}^{2} + {( \frac{{\partial }^{2} f}{\partial {y}^{2}} )}^{2} \vert & ( 20 ) \\ Q = w ( x , y ) {\vert \frac{\partial }{\partial {n}_{min}} ( \frac{\partial f}{\partial {n}_{min}} ) \vert}^{m} & ( 21 )\end{matrix}$$

In Equations (19) to (21), w (x, y) is a function representing the gradient of the pixel value and is also a weight function with respect to the constraint. The constraint can be changed adaptively to the gradient of f so that the w (x, y) value is small if the sum of the m^{th} powers of the pixel value gradient components as represented by the following Expression (22) is large but is large if the sum is small:

$${\vert \frac{\partial f}{\partial x} \vert}^{m} + {\vert \frac{\partial f}{\partial y} \vert}^{m} \qquad ( 22 )$$

By introducing such a weight function, it is possible to prevent the restored moving picture f from being smoothed out excessively.

Alternatively, the weight function w(x, y) may also be defined by the magnitude of the m^{th} power of the directional differential value as represented by the following Equation (23) instead of the sum of squares of the luminance gradient components represented by Expression (22):

$${\vert \frac{\partial f}{\partial {n}_{max}} \vert}^{m} = {\vert cos θ \frac{\partial f}{\partial x} + sin θ \frac{\partial f}{\partial y} \vert}^{m} \qquad ( 23 )$$

In Equation (24), the vector nₘₐₓ and the angle θ represent the direction in which the directional differential value becomes maximum and which is given by the following Equation (24):

$$\begin{matrix}{n}_{max} = {( \begin{matrix}\frac{\frac{\partial f}{\partial x}}{\sqrt{{( \frac{\partial f}{\partial x} )}^{2} + {( \frac{\partial f}{\partial y} )}^{2}}} & \frac{\frac{\partial f}{\partial y}}{\sqrt{{( \frac{\partial f}{\partial x} )}^{2} + {( \frac{\partial f}{\partial y} )}^{2}}}\end{matrix} )}^{T} \\ = {( \begin{matrix}cos θ & sin θ\end{matrix} )}^{T}\end{matrix} \qquad ( 24 )$$

The problem of solving Equation (4) by introducing a smoothness constraint on the distribution of the pixel values of a moving picture f as represented by Equations (12), (13) and (17) through (21) can be calculated by a known solution (i.e., a solution for a variational problem such as a finite element method).

As the smoothness constraint on the distribution of motions of the moving picture included in f, one of the following Equations (25) and (26) may be used:

$$\begin{matrix}Q = {\vert \frac{\partial u}{\partial x} \vert}^{m} + {\vert \frac{\partial u}{\partial y} \vert}^{m} + {\vert \frac{\partial v}{\partial x} \vert}^{m} + {\vert \frac{\partial v}{\partial y} \vert}^{m} & ( 25 ) \\ Q = {\vert \frac{{\partial }^{2} u}{\partial {x}^{2}} \vert}^{m} + {\vert \frac{{\partial }^{2} u}{\partial {y}^{2}} \vert}^{m} + {\vert \frac{{\partial }^{2} v}{\partial {x}^{2}} \vert}^{m} + {\vert \frac{{\partial }^{2} v}{\partial {y}^{2}} \vert}^{m} & ( 26 )\end{matrix}$$

where u is a column vector, of which the elements are x-direction components of motion vectors of respective pixels obtained from the moving picture f, and v is a column vector, of which the elements are y-direction components of motion vectors of respective pixels obtained from the moving picture f.

The smoothness constraint on the distribution of motions of the moving picture obtained from f does not have to be calculated by Equation (21) or (22) but may also be the first- or second-order directional differential value as represented by the following Equation (27) or (28):

$$\begin{matrix}Q = {\vert \frac{\partial u}{\partial {n}_{min}} \vert}^{m} + {\vert \frac{\partial v}{\partial {n}_{min}} \vert}^{m} & ( 27 ) \\ Q = {\vert \frac{\partial }{\partial {n}_{min}} ( \frac{\partial u}{\partial {n}_{min}} ) \vert}^{m} + {\vert \frac{\partial }{\partial {n}_{min}} ( \frac{\partial v}{\partial {n}_{min}} ) \vert}^{m} & ( 28 )\end{matrix}$$

Still alternatively, as represented by the following Equations (29) to (32), the constraints represented by the Equations (21) through (24) may also be changed adaptively to the gradient of the pixel value of f:

$$\begin{matrix}Q = w ( x , y ) ( {\vert \frac{\partial u}{\partial x} \vert}^{m} + {\vert \frac{\partial u}{\partial y} \vert}^{m} + {\vert \frac{\partial v}{\partial x} \vert}^{m} + {\vert \frac{\partial v}{\partial y} \vert}^{m} ) & ( 29 ) \\ Q = w ( x , y ) ( {\vert \frac{{\partial }^{2} u}{\partial {x}^{2}} \vert}^{m} + {\vert \frac{{\partial }^{2} u}{\partial {y}^{2}} \vert}^{m} + {\vert \frac{{\partial }^{2} v}{\partial {x}^{2}} \vert}^{m} + {\vert \frac{{\partial }^{2} v}{\partial {y}^{2}} \vert}^{m} ) & ( 30 ) \\ Q = w ( x , y ) ( {\vert \frac{\partial u}{\partial {n}_{min}} \vert}^{m} + {\vert \frac{\partial v}{\partial {n}_{min}} \vert}^{m} ) & ( 31 ) \\ Q = w ( x , y ) ( {\vert \frac{\partial }{\partial {n}_{min}} ( \frac{\partial u}{\partial {n}_{min}} ) \vert}^{m} + {\vert \frac{\partial }{\partial {n}_{min}} ( \frac{\partial v}{\partial {n}_{min}} ) \vert}^{m} ) & ( 32 )\end{matrix}$$

where w(x, y) is the same as the weight function on the gradient of the pixel value of f and is defined by either the sum of the m^{th} powers of pixel value gradient components as represented by Expression (22) or the m^{th} power of the directional differential value represented by Equation (23).

By introducing such a weight function, it is possible to prevent the motion information of f from being smoothed out unnecessarily. As a result, it is possible to avoid an unwanted situation where the restored image f is smoothed out excessively.

In dealing with the problem of solving Equation (4) by introducing the smoothness constraint on the distribution of motions obtained from the moving picture f as represented by Equations (25) through (32), more complicated calculations need to be done compared to the situation where the smoothness constraint on f is used. The reason is the moving picture f to be restored and the motion information (u, v) depend on each other.

To avoid such an unwanted situation, the calculations may also be done by a known solution (i.e., a solution for a variational problem using an EM algorithm). In that case, to perform iterative calculations, the initial values of the moving picture f to be restored and the motion information (u, v) are needed.

As the initial f value, an interpolated enlarged version of the input moving picture may be used. On the other hand, as the motion information (u, v), what has been calculated by the motion detecting section 201 using Equation (1) or (2) may be used. In that case, if the image quality improving section 105 solves Equation (4) by introducing the smoothness constraint on the distribution of motions obtained from the moving picture f as in Equations (25) through (32) and as described above, the image quality can be improved as a result of the super-resolution processing.

The image quality improving section 105 may perform its processing by using, in combination, the smoothness constraint on the distribution of pixel values as represented by one of Equations (12), (13) and (17) through (21) and the smoothness constraint on the distribution of motions as represented by Equations (25) through (32) as in the following Equation (33):

Q=λ₁Q_{f}+λ₂Qᵤᵥ (33)

where Q_{f} is the smoothness constraint on the pixel value gradient of f, Qᵤᵥ is the smoothness constraint on the distribution of motions of the moving picture obtained from f, and λ₁ and λ₂ are weights added to the constraints Q_{f} and Qᵤᵥ, respectively.

The problem of solving Equation (4) by introducing both the smoothness constraint on the distribution of pixel values and the smoothness constraint on the distribution of motions of the moving picture can also be calculated by a known solution (i.e., a solution for a variational problem using an EM algorithm).

The constraint on the motion does not have to be the constraint on the smoothness of the distribution of motion vectors as represented by Equations (25) through (32) but may also use the residual between two associated points (i.e., the difference in pixel value between the starting and end points of a motion vector) as an estimate value so as to reduce the residual as much as possible. If f is represented by the function f (x, y, t), the residual between the two associated points can be represented by the following Expression (34):

f(x+u,y+v,t+Δt)−f(x,y,t) (34)

If f is regarded as a vector that is applied to the entire moving picture, the residual of each pixel can be represented as a vector as in the following Expression (35):

Hₘf (35)

The sum of squared residuals can be represented by the following Equation (36):

(Hₘf)²=f^{T}Hₘ^{T}Hₘf (36)

In Expressions (35) and (36), Hₘ represents a matrix consisting of the number of elements of the vector f (i.e., the total number of pixels in the temporal or spatial range)×the number of elements of f. In Hₘ, only two elements of each row that are associated with the starting and end points of a motion vector have non-zero values, while the other elements have a zero value. Specifically, if the motion vector has an integer precision, the elements associated with the starting and end points have values of −1 and 1, respectively, but the other elements have a value of 0.

On the other hand, if the motion vector has a subpixel precision, multiple elements associated with multiple pixels around the end point will have non-zero values according to the subpixel component value of the motion vector.

Optionally, the constraint may be represented by the following Equation (37) with Equation (36) replaced by Qₘ:

Q=λ₁Q_{f}+λ₂Qᵤᵥ+λ₃Qₘ (37)

where λ3 is the weight with respect to the constraint Qₘ.

According to the method described above, by using the motion information that has been obtained from low-resolution moving pictures of R and B by the motion detecting section 201, a G moving picture that has been captured by an imager with a Bayer arrangement (i.e., an image G_{L} that has been accumulated in multiple frames and an image G_{S} that has been spatially added within one frame) can have its temporal and spatial resolutions increased by the image quality improving section 105.

<How to Restore R and B Pixel Values of Each Pixel>

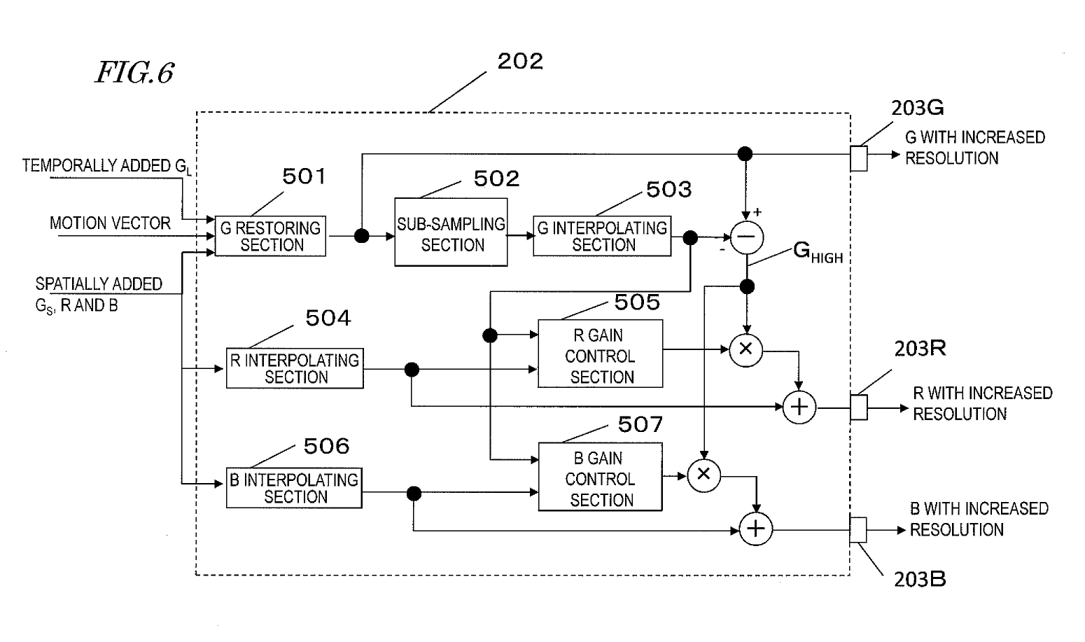

As for R and B, R and B images, of which the resolutions have been further increased through simple processing, can be output as a color moving picture. To do that, the high frequency components of G that has had its temporal and spatial resolutions increased as described above may be superposed on the R and B moving pictures as shown in FIG. 6. In that case, the amplitudes of high frequency components to superpose may be controlled according to the local correlation between R, G and B other than in a high frequency range (i.e., in middle to low frequency ranges). Then, a moving picture with natural appearance can have an increased resolution with the generation of false colors minimized.

In addition, since the high frequency components of G with increased temporal and spatial resolution are superposed, the resolutions of R and B can also be increased with more stability.

FIG. 6 illustrates an exemplary configuration for an image quality improvement processing section 202 that performs such an operation. The image quality improvement processing section 202 includes a G restoring section 501, a sub-sampling section 502, a G interpolating section 503, an R interpolating section 504, an R gain control section 505, a B interpolating section 506, a B gain control section 507 and output terminals 203G, 203R and 203B.

As described above, in this embodiment, two kinds of G moving pictures, that is, G_{L} that has been obtained through the temporal addition section and G_{S} that has been obtained through the spatial addition, are generated. That is why the image quality improvement processing section 202 includes a G restoring section 501 that restores the G moving picture.

The G restoring section 501 performs G restoration processing using G_{L} and G_{S} just as described above.

The sub-sampling section 502 reduces the resolution of G that has been increased to the same number of pixels as that of R and B by sub-sampling process.

The G interpolating section 503 performs the processing of bringing the number of pixels of G that has been once reduced by the sub-sampling section 502 up to the original one again. Specifically, the G interpolating section 503 calculates, by interpolation, the pixel values of pixels that have been lost through the sub-sampling process. The method of interpolation may be a known one. The sub-sampling section 502 and the G interpolating section 503 are provided in order to obtain high spatial frequency components of G based on G that has been supplied from the G restoring section 501 and G that has been subjected to sub-sampling and interpolation.

The R interpolating section 504 makes interpolation on R.

The R gain control section 505 calculates a gain coefficient with respect to the high frequency components of G to be superposed on R.

The B interpolating section 506 makes interpolation on B.

The B gain control section 507 calculates a gain coefficient with respect to the high frequency components of G to be superposed on B.

The output terminals 203G, 203R and 203B respectively output G, R and B that have had their resolution increased.

The method of interpolation adopted by the R and B interpolating sections 504 and 506 may be either the same as, or different from, the one adopted by the G interpolating section 503. Optionally, these interpolating sections 503, 504 and 505 may use mutually different methods of interpolation, too.

Hereinafter, it will be described how this image quality improvement processing section 202 operates.

The G restoring section 501 restores a G moving picture with a high resolution and a high frame rate by obtaining f that minimizes Equation (4) based on G_{L} that has been calculated by temporal addition and G_{S} that has been calculated by spatial addition with a constraint specified. Then, the G restoring section 501 outputs a result of the restoration as the G component of the output image to the sub-sampling section 502. In response, the sub-sampling section 502 sub-samples the G component that has been supplied.

The G interpolating section 503 makes interpolation on the G moving picture that has been sub-sampled by the sub-sampling section 502. As a result, the pixel values of pixels that have been once lost as a result of the sub-sampling can be calculated by making interpolation on surrounding pixel values. And by subtracting the G moving picture that has been subjected to the interpolation from the output of the G restoring section 501, the high spatial frequency components G_{high} of G can be extracted.

Meanwhile, the R interpolating section 504 interpolates and enlarges the R moving picture that has been spatially added so that the R moving picture has the same number of pixels as G. The R gain control section 505 calculates a local correlation coefficient between the output of the G interpolating section 503 (i.e., the low spatial frequency component of G) and the output of the R interpolating section 504. As the local correlation coefficient, the correlation coefficient of 3×3 pixels surrounding a pixel in question (x, y) may be calculated by the following Equation (38):

$$ρ = \frac{{\sum }_{i = - 1 , 0 , 1}^{3} {\sum }_{j = - 1 , 0 , 1}^{3} ( R ( x + i , y + j ) - \overline{R} ) ( G ( x + i , y + j ) - \overline{G} )}{\begin{matrix}\sqrt{{\sum }_{i = - 1 , 0 , 1}^{3} {\sum }_{j = - 1 , 0 , 1}^{3} {( R ( x + i , y + j ) - \overline{R} )}^{2}} \\ \sqrt{{\sum }_{i = - 1 , 0 , 1}^{3} {\sum }_{j = - 1 , 0 , 1}^{3} {( G ( x + i , y + j ) - \overline{G} )}^{2}}\end{matrix}} \\ where \\ \overline{R} = \frac{1}{9} {\sum }_{i = - 1 , 0 , 1}^{3} {\sum }_{j = - 1 , 0 , 1}^{3} R ( x + i , y + j ) \\ \overline{G} = \frac{1}{9} {\sum }_{i = - 1 , 0 , 1}^{3} {\sum }_{j = - 1 , 0 , 1}^{3} G ( x + i , y + j ) \qquad ( 38 )$$

The correlation coefficient that has been thus calculated between the low spatial frequency components of R and G is multiplied by the high spatial frequency component G_{high} of G and then the product is added to the output of the R interpolating section 504, thereby increasing the resolution of the R component.

The B component is also processed in the same way as the R component. Specifically, the B interpolating section 506 interpolates and enlarges the B moving picture that has been spatially added so that the B moving picture has the same number of pixels as G. The B gain control section 507 calculates a local correlation coefficient between the output of the G interpolating section 503 (i.e., the low spatial frequency component of G) and the output of the B interpolating section 506. As the local correlation coefficient, the correlation coefficient of 3×3 pixels surrounding the pixel in question (x, y) may be calculated by the following Equation (39):

$$ρ = \frac{{\sum }_{i = - 1 , 0 , 1}^{3} {\sum }_{j = - 1 , 0 , 1}^{3} ( B ( x + i , y + j ) - \overline{B} ) ( G ( x + i , y + j ) - \overline{G} )}{\begin{matrix}\sqrt{{\sum }_{i = - 1 , 0 , 1}^{3} {\sum }_{j = - 1 , 0 , 1}^{3} {( B ( x + i , y + j ) - \overline{B} )}^{2}} \\ \sqrt{{\sum }_{i = - 1 , 0 , 1}^{3} {\sum }_{j = - 1 , 0 , 1}^{3} {( G ( x + i , y + j ) - \overline{G} )}^{2}}\end{matrix}} \\ where \overline{B} = \frac{1}{9} {\sum }_{i = - 1 , 0 , 1}^{3} {\sum }_{j = - 1 , 0 , 1}^{3} B ( x + i , y + j ) \\ \overline{G} = \frac{1}{9} {\sum }_{i = - 1 , 0 , 1}^{3} {\sum }_{j = - 1 , 0 , 1}^{3} G ( x + i , y + j ) \qquad ( 39 )$$

The correlation coefficient that has been thus calculated between the low spatial frequency components of B and G is multiplied by the high spatial frequency component G_{high} of G and then the product is added to the output of the B interpolating section 506, thereby increasing the resolution of the B component.

The method of calculating G, R and B pixel values that is used by the restoration section 202 as described above is only an example. Thus, any other calculating method may be adopted as well. For example, the restoration section 202 may calculate R, G and B pixel values at the same time.

Specifically, in that case, the G restoring section 501 sets an evaluation function J representing the degree of similarity between the spatial variation patterns of respective color moving pictures the target color moving picture f should have, and looks for the target moving picture f that minimizes the evaluation function J. If their spatial variation patterns are similar, it means that the B, R and G moving pictures cause similar spatial variations.

The following Equation (40) shows an example of the evaluation function J:

J(f)=∥H_{R}R_{H}−R_{L}∥²+∥H_{G}G_{H}−G_{L}∥²+∥H_{B}B_{H}−B_{L}∥²+λ_{θ}∥Q_{S}C_{θ}f∥^{p}+λ_{φ}∥Q_{S}C_{φ}f∥^{p}+λ_{γ}∥Q_{S}C_{γ}f∥^{p} (40)

The evaluation function J is defined herein as a function of respective color moving pictures in red, green and blue that form the high-resolution color moving picture f to generate (i.e., the target image). Those color moving pictures will be represented herein by their image vectors R_{H}, G_{H} and B_{H}, respectively. In Equation (40), H_{R}, H_{G} and H_{B} represent a resolution decreasing conversion from the respective color moving pictures Rx, G_{H} and B_{H} of the target moving picture f into the respective input color moving pictures R_{L}, G_{L} and B_{L} (which are also represented by their vectors). In this case, H_{R}, H_{G} and H_{B} represent resolution decreasing conversions that are given by the following Equations (41), (42) and (43):

$$\begin{matrix}{R}_{L} ( {x}_{RL} , {y}_{RL} ) = {\sum }_{( {x}^{′} , {y}^{′} ) ∈ C} {w}_{R} ( {x}^{′} , {y}^{′} ) \cdot {R}_{H} ( x ( {x}_{RL} ) + {x}^{′} , y ( {y}_{RL} ) + {y}^{′} ) & ( 41 ) \\ {G}_{L} ( {x}_{GL} , {y}_{GL} ) = {\sum }_{( {x}^{′} , {y}^{′} ) ∈ C} {w}_{G} ( {x}^{′} , {y}^{′} ) \cdot {G}_{H} ( x ( {x}_{GL} ) + {x}^{′} , y ( {y}_{GL} ) + {y}^{′} ) & ( 42 ) \\ {B}_{L} ( {x}_{BL} , {y}_{BL} ) = {\sum }_{( {x}^{′} , {y}^{′} ) ∈ C} {w}_{B} ( {x}^{′} , {y}^{′} ) \cdot {B}_{H} ( x ( {x}_{BL} ) + {x}^{′} , y ( {y}_{BL} ) + {y}^{′} ) & ( 43 )\end{matrix}$$

The pixel value of each input moving picture is the sum of weighted pixel values in a local area that surrounds an associated location in the target moving picture.

In these Equations (41), (42) and (43), R_{H}(x, y), G_{H}(x, y) and B_{H}(x, y) represent the respective values of red (R), green (G) and blue (B) pixels at a pixel location (x, y) on the target moving picture f. Also, R_{L}(x_{RL}, y_{RL}), G_{L}(x_{GL}, y_{GL}) and B_{L}(x_{BL}, y_{BL}) represent the pixel value at a pixel location (x_{RL}, y_{RL}) on the R input image, the pixel value at a pixel location (x_{GL}, y_{GL}) on the G input image, and the pixel value at a pixel location (x_{BL}, y_{BL}) on the B input image, respectively. x(x_{RL}) and y(y_{RL}) represent the x and y coordinates at a pixel location on the target moving picture that is associated with the pixel location (x_{GL}, y_{GL}) on the input R image. x(x_{GL}) and y(y_{GL}) represent the x and y coordinates at a pixel location on the target moving picture that is associated with the pixel location (x_{GL}, y_{GL}) on the input G image. And x(x_{BL}) and y(y_{BL}) represent the x and y coordinates at pixel location on the target moving picture that is associated with the pixel location (x_{BL}, y_{BL}) on the input B image. Also, w_{R}, w_{G} and w_{B} represent the weight functions of pixel values of the target moving picture, which are associated with the pixel values of the input R, G and B moving pictures, respectively. It should be noted that (x′, y′)εC represents the range of the local area where w_{R}, w_{G} and w_{B} are defined.

The sum of squared differences between the pixel values at multiple pixel locations on the low resolution moving picture and the ones at their associated pixel locations on the input moving picture is set to be an evaluation condition for the evaluation function (see the first, second and third terms of Equation (40)). That is to say, these evaluation conditions are set by a value representing the magnitude of the differential vector between a vector consisting of the respective pixel values of the low resolution moving picture and a vector consisting of the respective pixel values of the input moving picture.

The fourth term Qₛ of Equation (40) is an evaluation condition for evaluating the spatial smoothness of a pixel value.

Qₛ₁ and Qₛ₂, which are examples of Qₛ, are represented by the following Equations (44) and (45), respectively:

$${Q}_{s 1} = {\sum }_{x} {\sum }_{y} [ \begin{matrix}{λ}_{θ} ( x , y ) \cdot {\{ 4 \cdot {θ}_{H} ( x , y ) - {θ}_{H} ( x , y - 1 ) - {θ}_{H} ( x , y + 1 ) - {θ}_{H} ( x - 1 , y ) - {θ}_{H} ( x + 1 , y ) \}}^{2} + \\ {λ}_{ϕ} ( x , y ) \cdot {\{ 4 \cdot {ϕ}_{H} ( x , y ) - {ϕ}_{H} ( x , y - 1 ) - {ϕ}_{H} ( x , y + 1 ) - {ϕ}_{H} ( x - 1 , y ) - {ϕ}_{H} ( x + 1 , y ) \}}^{2} + \\ {λ}_{r} ( x , y ) \cdot {\{ 4 \cdot {r}_{H} ( x , y ) - {r}_{H} ( x , y - 1 ) - {r}_{H} ( x , y + 1 ) - {r}_{H} ( x - 1 , y ) - {r}_{H} ( x + 1 , y ) \}}^{2} \end{matrix} ] \qquad ( 44 )$$

In Equation (44), θ_{H}(x, y), ψ_{H}(x, y) and r_{H}(x, y) are coordinates when a position in a three-dimensional orthogonal color space (i.e., a so-called “RGB color space”) that is represented by red, green and blue pixel values at a pixel location (x, y) on the target moving picture is represented by a spherical coordinate system (θ, ψ, r) corresponding to the RGB color space. In this case, θ_{H}(x, y) and ψ_{H}(x, y) represent two kinds of arguments and r_{H}(x, y) represents the radius.

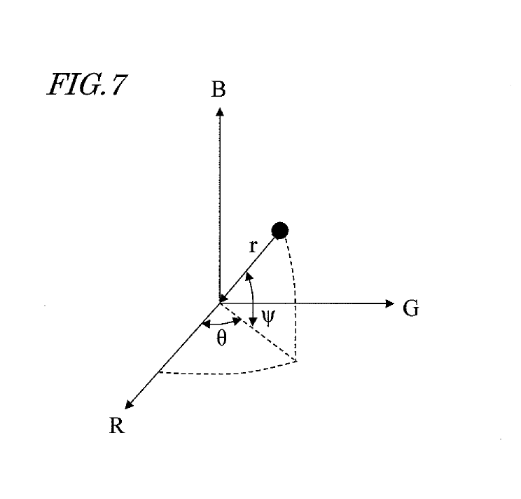

FIG. 7 illustrates an exemplary correspondence between the RGB color space and the spherical coordinate system (θ, ψ, r).

In the example illustrated in FIG. 7, the direction in which θ=0 degrees and ψ==0 degrees is supposed to be positive R-axis direction in the RGB color space, and the direction in which θ==90 degrees and ψ==0 degrees is supposed to be positive G-axis direction in the RGB color space. However, the reference directions of the arguments do not have to be the ones shown in FIG. 7 but may also be any other directions. In accordance with such correspondence, red, green and blue pixel values, which are coordinates in the RGB color space, are converted into coordinates in the spherical coordinate system (θ, ψ, r).

Suppose the pixel value of each pixel of the target moving picture is represented by a three-dimensional vector in the RGB color space. In that case, if the three-dimensional vector is represented by the spherical coordinate system (θ, ψ, r) that is associated with the RGB color space, then the brightness (which is synonymous with the signal intensity and the luminance) of the pixel corresponds to the r-axis coordinate representing the magnitude of the vector. On the other hand, the directions of vectors representing the color (i.e., color information including the hue, color difference and color saturation) of the pixel are defined by θ-axis and ψ-axis coordinate values. That is why by using the spherical coordinate system (θ, ψ, r), the three parameters r, θ and ψ that define the brightness and color of each pixel can be dealt with independently of each other.

Equation (44) defines the sum of squared second-order differences in the xy space direction between pixel values that are represented by the spherical coordinate system of the target moving picture. Equation (44) also defines a condition Qₛ₁ on which the more uniformly the spherical coordinate system pixel values, which are associated with spatially adjacent pixels in the target moving picture, vary, the smaller their values become. Generally speaking, if pixel values vary uniformly, then it means that the colors of those pixels are continuous with each other. Also, if the condition Qₛ₁ should have a small value, then it means that the colors of spatially adjacent pixels in the target moving picture should be continuous with each other.

In a moving picture, the variation in the brightness of a pixel and the variation in the color of that pixel may be caused by two physically different events. That is why by separately setting a condition on the continuity of a pixel's brightness (i.e., the degree of uniformity of the variation in r-axis coordinate value) as in the third term in the bracket of Equation (44) and a condition on the continuity of the pixel's color (i.e., the degree of uniformity in the variations in θ- and ψ-axis coordinate values) as in the first and second terms in the bracket of Equation (44), the target image quality can be achieved more easily.

λ_{θ}(x, y), λ_{ψ}(x, y) and λᵣ(x, y) represent the weights to be applied to a pixel location (x, y) on the target moving picture with respect to the conditions that have been set with the θ-, ψ- and r-axis coordinate values, respectively. These values are determined in advance. To simplify the computation, these weights may be set to be constant irrespective of the pixel location or the frame so that λ_{θ}(x, y)=λ_{ψ}(x, y)=1.0, and λᵣ(x, y)=0.01, for example. Alternatively, these weights may be set to be relatively small in a portion of the image where it is known in advance that pixel values should be discontinuous, for instance. Optionally, pixel values can be determined to be discontinuous with each other if the absolute value of the difference or the second-order difference between the pixel values of two adjacent pixels in a frame image of the input moving picture is equal to or greater than a particular value.

It is preferred that the weights applied to the condition on the continuity of the color of pixels be heavier than the weights applied to the condition on the continuity of the brightness of the pixels. This is because the brightness of pixels in an image tends to vary more easily (i.e., vary less uniformly) than its color when the orientation of the subject's surface (i.e., a normal to the subject's surface) changes due to the unevenness or the movement of the subject's surface.

In Equation (44), the sum of squared second-order differences in the xy space direction between the pixel values, which are represented by the spherical coordinate system on the target moving picture, is set as the condition Qₛ₁. Alternatively, the sum of the absolute values of the second-order differences or the sum of squared first-order differences or the sum of the absolute values of the first-order differences may also be set as that condition Qₛ₁.

Also, in the foregoing description, the color space condition is set using the spherical coordinate system (θ, ψ, r) that is associated with the RGB color space. However, the coordinate system to use does not always have to be the spherical coordinate system. Rather the same effects as what has already been described can also be achieved by setting a condition on a different orthogonal coordinate system with axes of coordinates that make the brightness and color of pixels easily separable from each other.

The axes of coordinates of the different orthogonal coordinate system may be set in the directions of eigenvectors (i.e., may be the axes of eigenvectors), which are defined by analyzing the principal components of the RGB color space frequency distribution of pixel values that are included in the input moving picture or another moving picture as a reference.

$${Q}_{s 2} = {\sum }_{x} {\sum }_{y} [ \begin{matrix}{λ}_{C 1} ( x , y ) \cdot {\{ 4 \cdot {C}_{1} ( x , y ) - {C}_{1} ( x , y - 1 ) - {C}_{1} ( x , y + 1 ) - {C}_{1} ( x - 1 , y ) - {C}_{1} ( x + 1 , y ) \}}^{2} + \\ {λ}_{C 2} ( x , y ) \cdot {\{ 4 \cdot {C}_{2} ( x , y ) - {C}_{2} ( x , y - 1 ) - {C}_{2} ( x , y + 1 ) - {C}_{2} ( x - 1 , y ) - {C}_{2} ( x + 1 , y ) \}}^{2} + \\ {λ}_{C 3} ( x , y ) \cdot {\{ 4 \cdot {C}_{3} ( x , y ) - {C}_{3} ( x , y - 1 ) - {C}_{3} ( x , y + 1 ) - {C}_{3} ( x - 1 , y ) - {C}_{3} ( x + 1 , y ) \}}^{2}\end{matrix} ] \qquad ( 45 )$$

In Equation (45), C₁(x, y), C₂(x, y) and C₃(x, y) represent rotational transformations that transform RGB color space coordinates, which are red, green and blue pixel values at a pixel location (x, y) on the target moving picture, into coordinates on the axes of C₁, C₂ and C₃ coordinates of the different orthogonal coordinate system.

Equation (45) defines the sum of squared second-order differences in the xy space direction between pixel values of the target moving picture that are represented by the different orthogonal coordinate system. Also, Equation (45) defines a condition Qₛ₂. In this case, the more uniformly the pixel values of spatially adjacent pixels in each frame image of the target moving picture, which are represented by the different orthogonal coordinate system, vary (i.e., the more continuous those pixel values), the smaller the value of the condition Qₛ₂.

And if the value of the condition Qₛ₂ should be small, it means that the colors of spatially adjacent pixels on the target moving picture should have continuous colors.

λ_{C1}(x, y), λ_{C2}(x, y) and λ_{C3}(x, y) are weights applied to a pixel location (x, y) on the target moving picture with respect to a condition that has been set using coordinates on the C₁, C₂ and C₃ axes and need to be determined in advance.

If the C₁, C₂ and C₃ axes are axes of eigenvectors, then the λ_{C1}(x, y), λ_{C2}(x, y) and λ_{C3}(x, y) values are preferably set along those axes of eigenvectors independently of each other. Then, the best 1 values can be set according to the variance values that are different from one axis of eigenvectors to another. Specifically, in the direction of a non-principal component, the variance should be small and the sum of squared second-order differences should decrease, and therefore, the λ value is increased. Conversely, in the principal component direction, the λ value is decreased.

Two conditions Qₛ₁ and Qₛ₂ have been described as examples. And the condition Qₛ may be any of the two conditions Qₛ₁ and Qₛ₂ described above.

For example, if the condition Qₛ₁ defined by Equation (44) is adopted, the spherical coordinate system (θ, ψ, r) is preferably introduced. Then, the condition can be set using the coordinates on the θ- and ψ-axes that represent color information and the coordinate on the r-axis that represents the signal intensity independently of each other. In addition, in setting the condition, appropriate weight parameters λ can be applied to the color information and the signal intensity, respectively. As a result, a moving picture of quality can be generated more easily, which is beneficial.

On the other hand, if the condition Qₛ₂ defined by Equation (45) is adopted, then the condition is set with coordinates of a different orthogonal coordinate system that is obtained by performing a linear (or rotational) transformation on RGB color space coordinates. Consequently, the computation can be simplified, which is also advantageous.

On top of that, by defining the axes of eigenvectors as the axes of coordinates C₁, C₂ and C₃ of the different orthogonal coordinate system, the condition can be set using the coordinates on the axes of eigenvectors that reflect a color variation to affect an even greater number of pixels. As a result, the quality of the target moving picture obtained should improve compared to a situation where the condition is set simply by using the pixel values of the respective color components in red, green and blue.

The evaluation function J does not have to be the one described above. Alternatively, terms of Equation (40) may be replaced with terms of a similar equation or another term representing a different condition may be newly added thereto.

Next, respective pixel values of a target moving picture that will make the value of the evaluation function J represented by Equation (40) as small as possible (and will preferably minimize it) are obtained, thereby generating respective color moving pictures R_{H}, G_{H} and B_{H} of the target moving picture.

The target moving picture f that will minimize the evaluation function J may also be obtained by solving the following Equation (46) in which every J differentiated by the pixel value component of each color moving picture R_{H}, G_{H}, B_{H} is supposed to be zero if the exponent p in Equation (40) is two:

$$\frac{\partial J}{\partial {R}_{H} ( x , y )} = \frac{\partial J}{\partial {G}_{H} ( x , y )} = \frac{\partial J}{\partial {B}_{H} ( x , y )} = 0 \qquad ( 46 )$$

The differentiation expression on each side becomes equal to zero when the gradient of each second-order expression represented by an associated term of Equation (40) becomes equal to zero. R_{H}, G_{H} and B_{H} in such a situation can be said to be the ideal target moving picture that gives the minimum value of each second-order expression. The target moving picture is obtained by using a conjugate gradient method as an exemplary method for solving a large-scale simultaneous linear equation.

On the other hand, unless the exponent p in Equation (40) is two, the evaluation function J needs to be minimized by nonlinear optimization. In that case, the target moving picture may also be obtained by an optimizing technique that requires iterative computations such as the steepest gradient method.

In the embodiment described above, the color moving picture to output is supposed to consist of R, G and B components. Naturally, however, a color moving picture consisting of non-RGB components (e.g., Y, Pb and Pr) may also be output. That is to say, the change of variables represented by the following Equation (48) can be done based on Equations (46) and (47):

$$\begin{matrix} ( \begin{matrix}R \\ G \\ B\end{matrix} ) = ( \begin{matrix}1 & - 0.00015 & 1.574765 \\ 1 & - 0.18728 & - 0.46812 \\ 1 & 1.85561 & 0.000106\end{matrix} ) ( \begin{matrix}Y \\ Pb \\ Pr\end{matrix} ) & ( 47 ) \\ ( \begin{matrix}\frac{\partial J}{\partial {Y}_{H} ( x , y )} \\ \frac{\partial J}{\partial {Pb}_{H} ( x , y )} \\ \frac{\partial J}{\partial {Pr}_{H} ( x , y )}\end{matrix} ) = ( \begin{matrix}\frac{\partial J}{\partial {R}_{H} ( x , y )} \frac{\partial {R}_{H} ( x , y )}{\partial {Y}_{H} ( x , y )} + \frac{\partial J}{\partial {G}_{H} ( x , y )} \frac{\partial {G}_{H} ( x , y )}{\partial {Y}_{H} ( x , y )} + \frac{\partial J}{\partial {B}_{H} ( x , y )} \frac{\partial {B}_{H} ( x , y )}{\partial {Y}_{H} ( x , y )} \\ \frac{\partial J}{\partial {R}_{H} ( x , y )} \frac{\partial {R}_{H} ( x , y )}{\partial {Pb}_{H} ( x , y )} + \frac{\partial J}{\partial {G}_{H} ( x , y )} \frac{\partial {G}_{H} ( x , y )}{\partial {Pb}_{H} ( x , y )} + \frac{\partial J}{\partial {B}_{H} ( x , y )} \frac{\partial {B}_{H} ( x , y )}{\partial {Pb}_{H} ( x , y )} \\ \frac{\partial J}{\partial {R}_{H} ( x , y )} \frac{\partial {R}_{H} ( x , y )}{\partial {Pr}_{H} ( x , y )} + \frac{\partial J}{\partial {G}_{H} ( x , y )} \frac{\partial {G}_{H} ( x , y )}{\partial {Pr}_{H} ( x , y )} + \frac{\partial J}{\partial {B}_{H} ( x , y )} \frac{\partial {B}_{H} ( x , y )}{\partial {Pr}_{H} ( x , y )}\end{matrix} ) = ( \begin{matrix}1 & 1 & 1 \\ - 0.00015 & - 0.18728 & 1.85561 \\ 1.574765 & - 0.46812 & 0.000106\end{matrix} ) ( \begin{matrix}\frac{\partial J}{\partial {R}_{H} ( x , y )} \\ \frac{\partial J}{\partial {G}_{H} ( x , y )} \\ \frac{\partial J}{\partial {B}_{H} ( x , y )}\end{matrix} ) = 0 & ( 48 )\end{matrix}$$

Furthermore, suppose a video signal representing the color moving picture described above is a normal video signal (YPbPr=4:2:2). In that case, by using the relations represented by the following Equations (49) with the fact that Pb and Pr have a half the number of horizontal pixels as Y taken into consideration, simultaneous equations can be formulated with respect to Y_{H}, Pb_{L} and Pr_{L}.

Pb_{L}(x+0.5)=0.5(Pb_{H}(x)+Pb_{H}(x+1))

Pr_{L}(x+0.5)=0.5(Pr_{H}(x)+Pr_{H}(x+1)) (49)

In that case, the total number of variables to be obtained by solving the simultaneous equations can be reduced to two-thirds compared to the situation where the color image to output consists of R, G and B components. As a result, the computational load can be cut down.

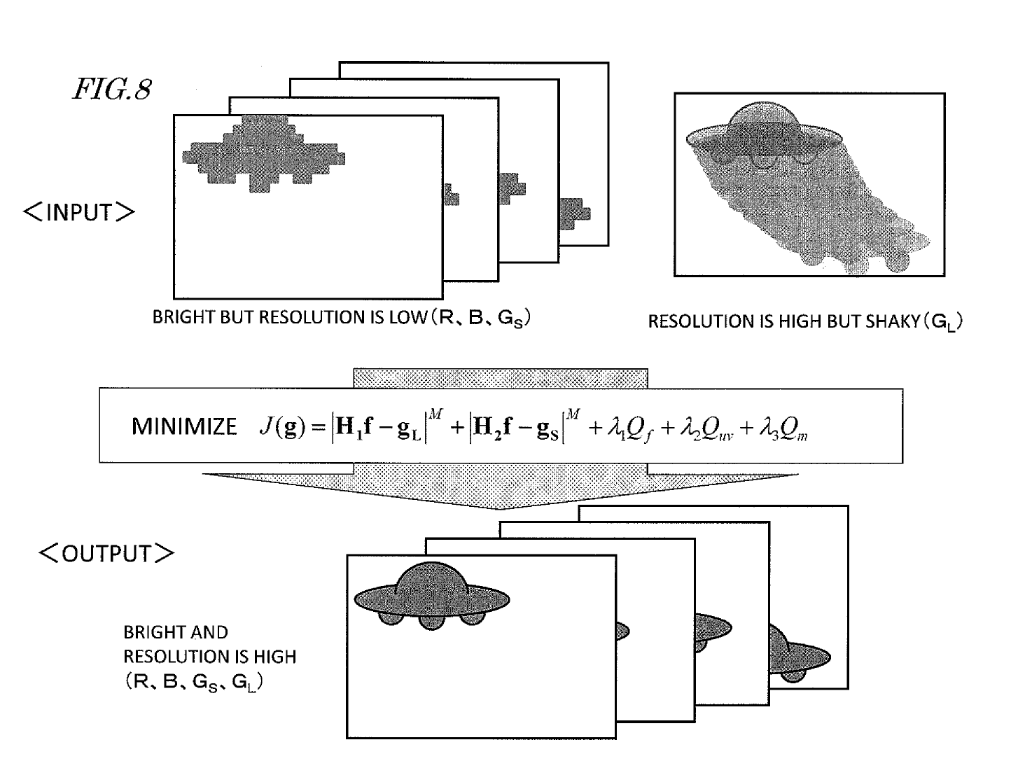

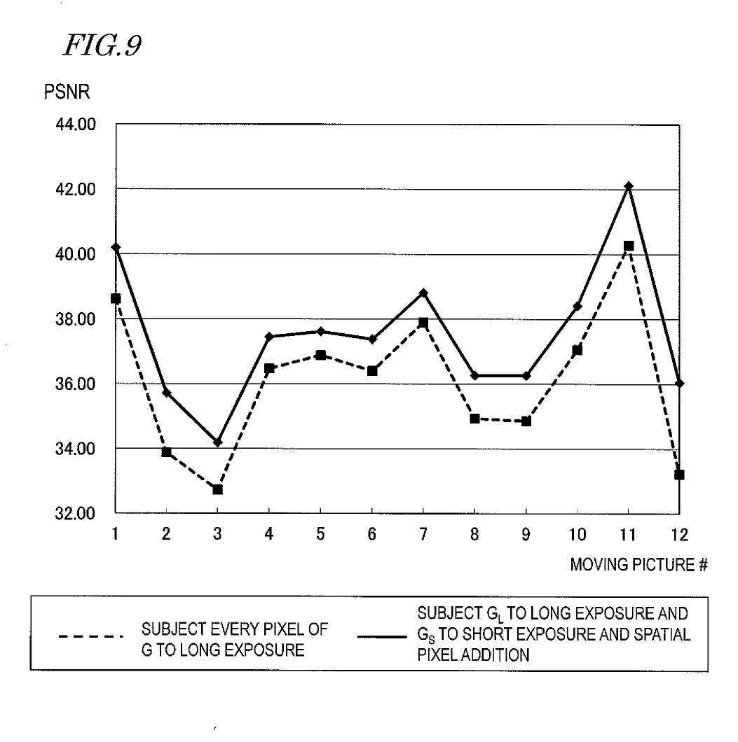

FIG. 8 illustrates diagrammatically what input and output moving pictures are like in the processing of this first embodiment.

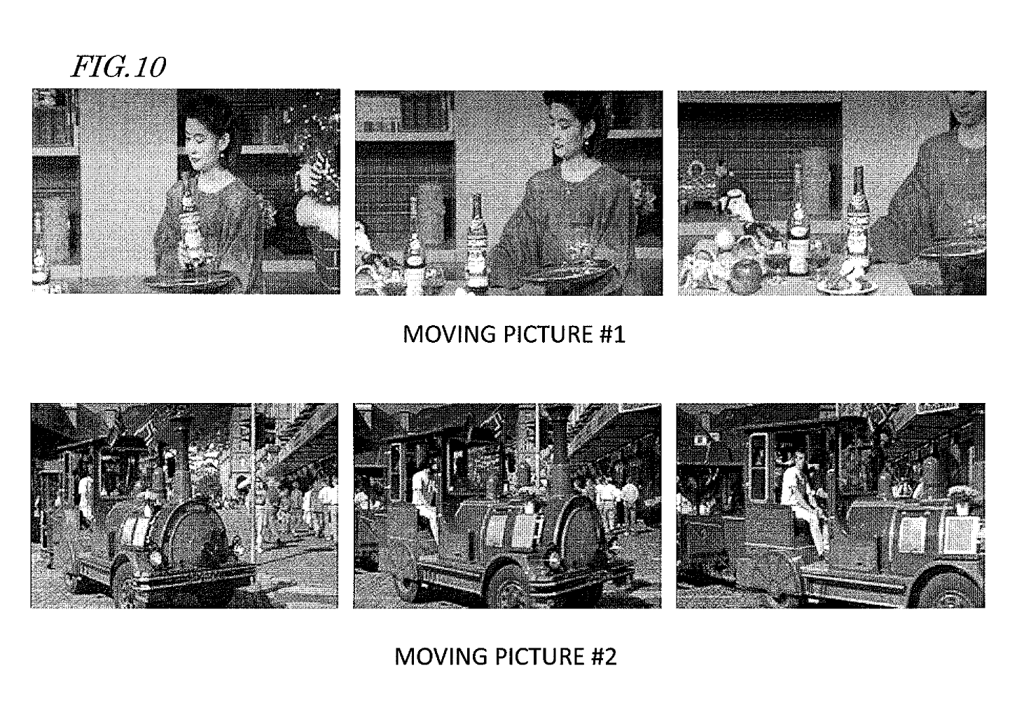

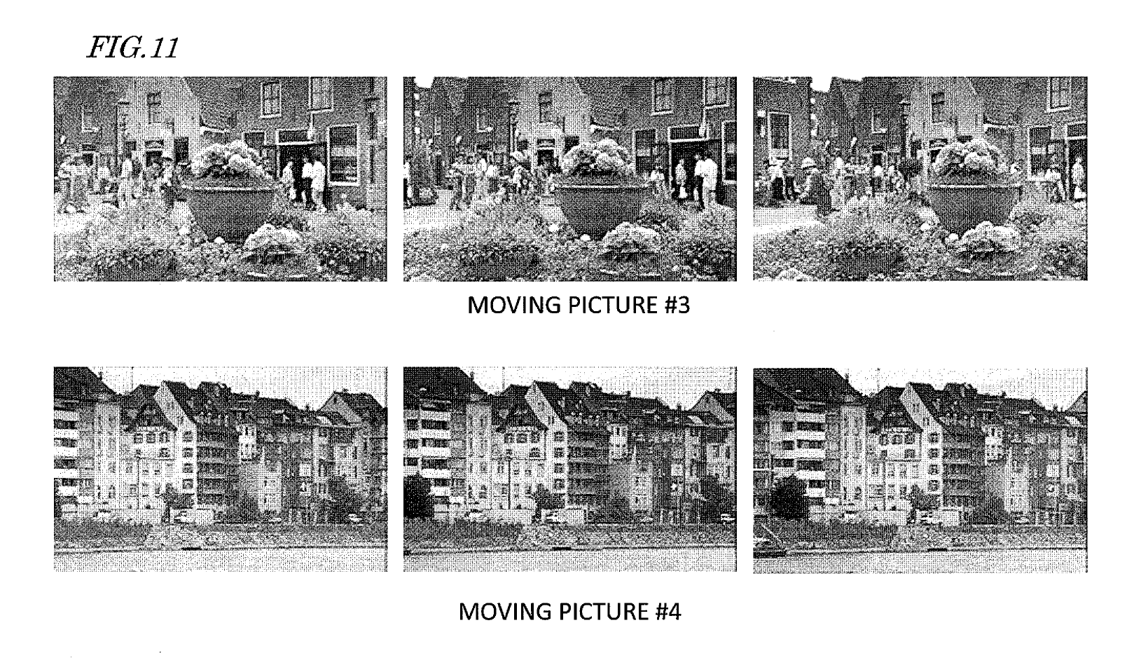

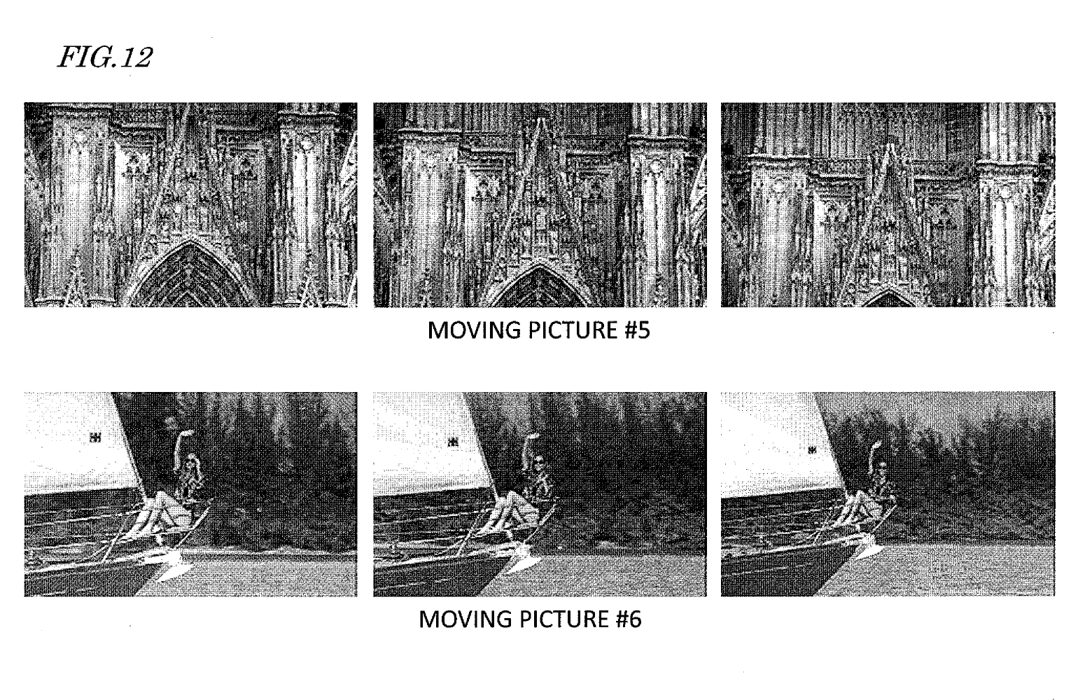

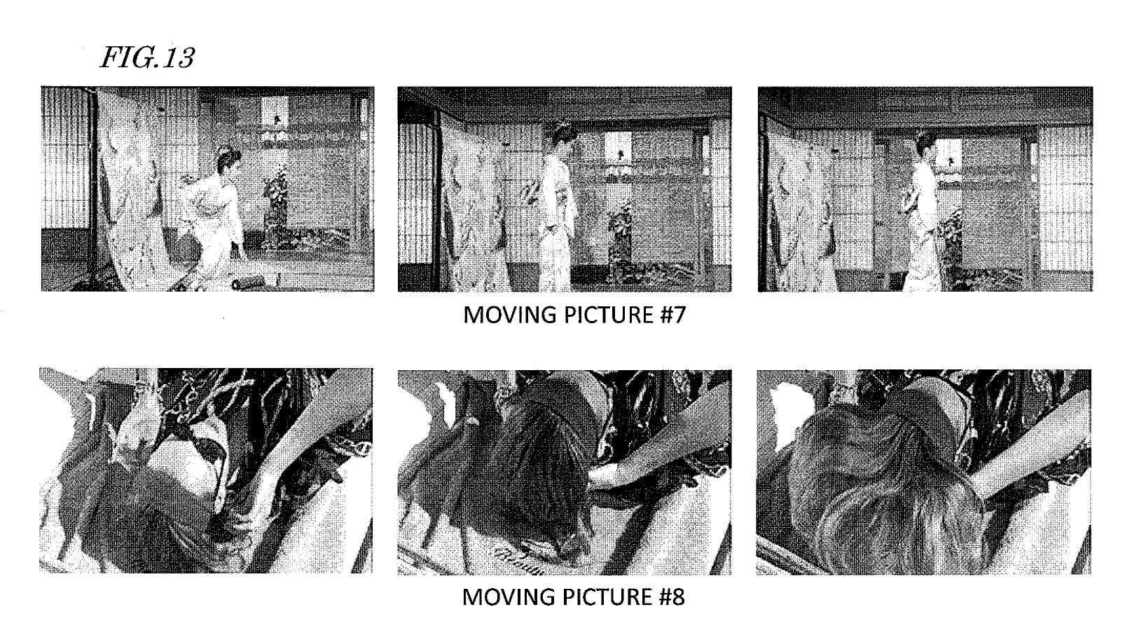

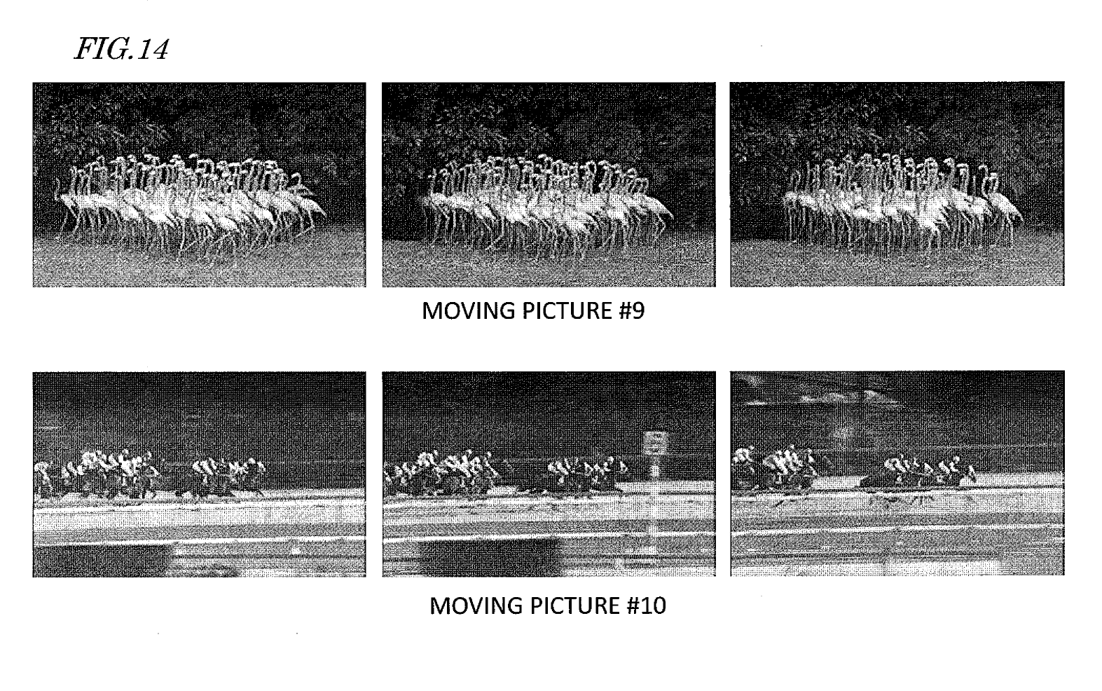

Meanwhile, FIG. 9 shows what PSNR values are obtained by a single imager in a situation where every G pixel is subjected to an exposure process for a long time and in a situation where it is processed by the method proposed for this first embodiment. As can be seen, according to the method proposed for the first embodiment, higher PSNR values can be obtained compared to a situation where every G pixel is subjected to an exposure process for a long time, and the image quality can be improved by nearly 2 dB in most moving pictures. This comparative experiment was carried out using twelve moving pictures. And three frames of each of those moving pictures (i.e., three still pictures that have an interval of 50 frames between them) are shown in FIGS. 10 through 15.

As described above, according to this first embodiment, the single imager is provided with additional functions of temporal addition and spatial addition and an input moving picture, which has been subjected to either the temporal addition or the spatial addition on a pixel-by-pixel basis, is subjected to restoration processing. As a result, a moving picture that has a high resolution, a high frame rate, and little shakiness due to some movement (i.e., a moving picture, of which every pixel has been read without performing spatial addition or temporal addition) can be estimated and restored with plenty of light used for shooting.

Even though it has been described how to generate a moving picture as an example, the image quality improvement processing section 202 may not only generate such a moving picture but also output the degree of reliability of the moving picture thus generated as well. The “degree of reliability γ” when a moving picture is generated is a value indicating how fast the moving picture would have been generated accurately and how much its resolution would have been increased. γ may be determined by calculating the total sum of the degrees of reliability of motion by the following Equation (50) or by calculating the N/M ratio of the number N of valid constraints to the total number M of pixels of the moving picture to generate (where M=the number of frames×the number of pixels per frame image), for example. In this case, N=Nh+Nl+Nλ×C, where Nh is the total number of pixels of a high-speed image (i.e., the number of frames×the number of pixels per frame image), Nl is the total number of pixels of a low-speed image, and Nλ is the number of kinds of external constraints at a temporal and spatial position (x, y, t) where the external constraints are validated.

$$γ = {\sum }_{x = 0}^{X max} {\sum }_{y - 0}^{Y max} {\sum }_{t = 0}^{T max} conf ( x , y , t ) \qquad ( 50 )$$

If an equation such as Equation (40) needs to be solved as a simultaneous linear equation, the number of conditions for obtaining a moving picture as a stable solution in the computational equation described by Cline, A. K Moler, C. B., Stewart, G. W. and Wilkinson, J. H. in “An Estimate for the Condition Number of a Matrix”, SIAM J. Num. Anal. vol. 16, No. 2 (1979), pp. 368-375 may be used as the degree of reliability.

If the degree of reliability obtained by the motion detecting section 201 is high, then the degree of reliability of a moving picture that has been generated using a motion constraint based on a result of the motion detection should also be high. Also, if the number of valid constraints is large for the total number of pixels of the moving picture to generate, then the moving picture generated as a solution can be obtained with good stability and the degree of reliability of the moving picture generated should also be high. Likewise, even if the number of conditions is small, the error of the solution should be little, and therefore, the degree of reliability of the moving picture generated should be high, too.

By outputting the degree of reliability of the moving picture generated in this manner, when the moving picture generated is subjected to an MPEG compression encoding, for example, the image quality improvement processing section 202 can change the compression rate depending on whether the degree of reliability is high or low. For the reasons to be described later, if the degree of reliability is low, the image quality improvement processing section 202 may raise the compression rate. Conversely, if the degree of reliability is high, the image quality improvement processing section 202 may lower the compression rate. In this manner, the compression rate can be set appropriately.

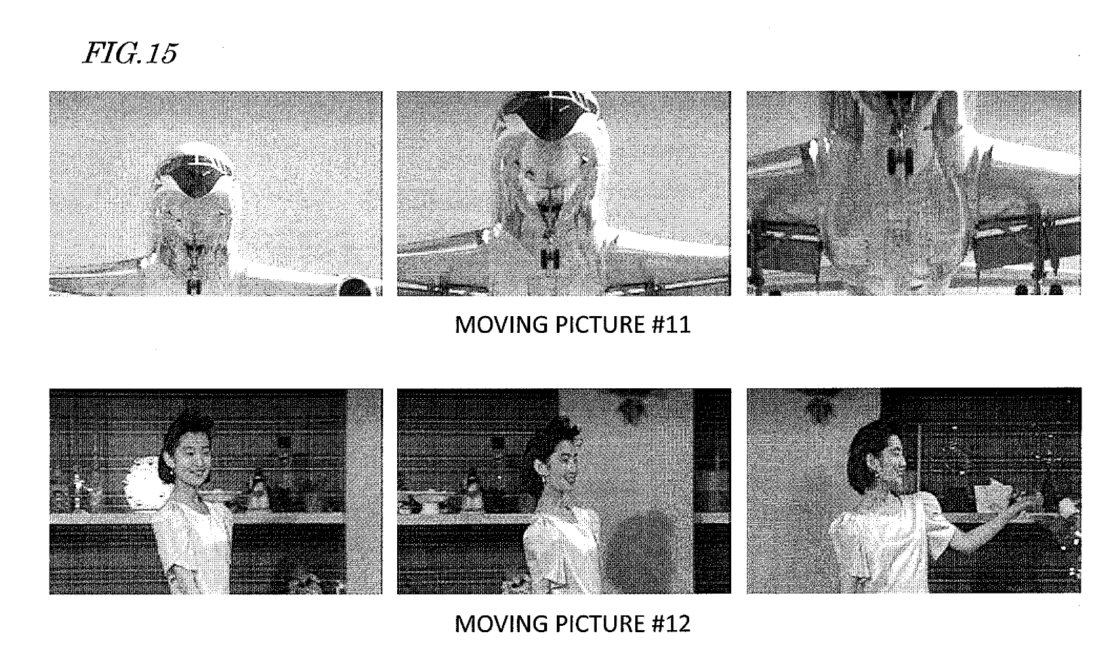

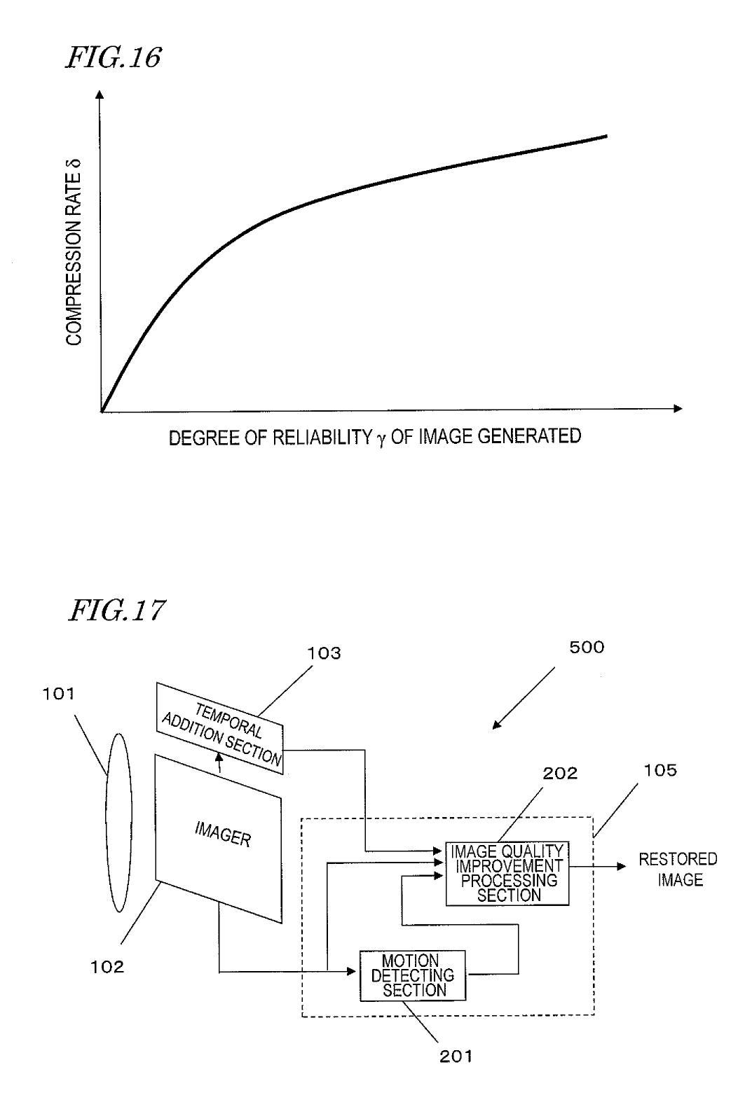

FIG. 16 shows how the compression rate δ for encoding needs to be changed according to the degree of reliability γ of the moving picture generated. By setting the relation between the degree of reliability γ and the compression rate δ to be a monotonically increasing one as shown in FIG. 16, the image quality improvement processing section 202 performs encoding with the compression rate δ adjusted according to the degree of reliability γ of the moving picture generated. If the degree of reliability γ of the moving picture generated is low, then the moving picture generated could have an error. That is why even if the compression rate is increased, information would not be lost so much as to debase the image quality significantly. Consequently, the data size can be cut down effectively. In this description, the “compression rate” means the ratio of the data size of encoded data to that of the original moving picture. Thus, the higher (or the greater) the compression rate, the smaller the size of the data encoded and the lower the quality of the image decoded will be.

In the same way, in the case of MPEG encoding, for example, if frames with high degrees of reliability are preferentially subjected to intra-frame coding (e.g., used as I-pictures) and if the other frames are subjected to inter-frame coding, then the image quality can be improved when a moving picture being played back is fast-forwarded or given a pause. In this description, when the degree of reliability is said to be “high” or “low”, it means that the degree of reliability is higher or lower than a predetermined threshold value.

For example, the degrees of reliability of the moving picture generated may be obtained on a frame-by-frame basis and may be represented by γ(t), where t is a frame time. In choosing a frame to be intra-frame coded from a series of frames, either a frame, of which γ(t) is greater than a predetermined threshold value γth, or a frame, of which γ(t) is the greatest in a predetermined continuous frame interval, may be selected. In that case, the image quality improvement processing section 202 may output the degree of reliability γ(t) thus calculated along with the moving picture.

Optionally, the image quality improvement processing section 202 may decompose the low-speed moving picture into luminance and color difference moving pictures and may increase the frame rate and resolution of only the luminance moving picture through the processing described above. The luminance moving picture that has had its frame rate and resolution increased in this manner will be referred to herein as an “intermediate moving picture”. The image quality improvement processing section 202 may generate the moving picture by complementing and expanding color difference information and adding that complemented and expanded information to the intermediate moving picture. According to such processing, the principal component of the moving picture is included in the luminance moving picture. That is why even if information about the color difference is complemented and expanded, the final moving picture may be generated by using both of the luminance and color difference moving pictures. Then a moving picture that has a higher frame rate and a higher resolution than the input image can still be obtained. On top of that, compared to a situation where R, G and B moving pictures are processed independently of each other, the complexity of processing can be cut down, too.

Furthermore, the image quality improvement processing section 202 may compare the magnitude of temporal variation (e.g., the sum of squared differences SSD) between adjacent frame images to a predetermined threshold value with respect to at least one of R, G and B moving pictures. If the SSD is greater than the threshold value, the image quality improvement processing section 202 may define the boundary between a frame at a time t when the sum of squared differences SSD has been calculated and a frame at a time t+1 as a processing boundary and may perform processing on the sequence at and before the time t and on the sequence from the time t+1 on separately from each other. More specifically, if the magnitude of variation calculated is not greater than a predetermined value, the image quality improvement processing section 202 does not make calculations to generate the moving picture but outputs an image that has been generated before the time t. And as soon as the magnitude of variation exceeds the predetermined value, the image quality improvement processing section 202 starts the processing of generating a new moving picture. Then, the degree of discontinuity between the results of processing on temporally adjacent areas becomes a negligible one compared to a change of the image between the frames, and therefore, should be less sensible. Consequently, the number of times of iterative computations can be reduced in generating an image.

### Embodiment 2

In the first embodiment described above, the number of spatially added pixels is used with respect to G_{S}, R and B. Hereinafter, a method for restoring a moving picture without making the spatial addition for G_{S}, R and B will be described as a second specific embodiment of the present disclosure.

FIG. 17 illustrates a configuration for an image capturing processor 500 according to the second embodiment of the present disclosure. In FIG. 17, any component also shown in FIG. 1 and performing the same operation as its counterpart is identified by the same reference numeral and description thereof will be omitted herein.

Compared to the image capturing processor 100 shown in FIG. 1, the image capturing processor 500 shown in FIG. 17 has no spatial addition section 104. In this image capturing processor 500, the output of the imager 102 is supplied to the motion detecting section 201 and image quality improvement processing section 202 of the image quality improving section 105. The output of the temporal addition section 103 is also supplied to the image quality improvement processing section 202.

Hereinafter, it will be described with reference to FIG. 18 what configuration the image quality improvement processing section 202 has and how the processing section 202 works.

FIG. 18 illustrates a detailed configuration for the image quality improvement processing section 202, which includes a G simplified restoration section 1901, the R interpolating section 504, the B interpolating section 506, a gain control section 507a and another gain control section 507b.

First of all, the G simplified restoration section 1901 will be described in detail.

Compared to the G restoring section 501 that has already been described for the first embodiment, the G simplified restoration section 1901 requires a lighter computational load.

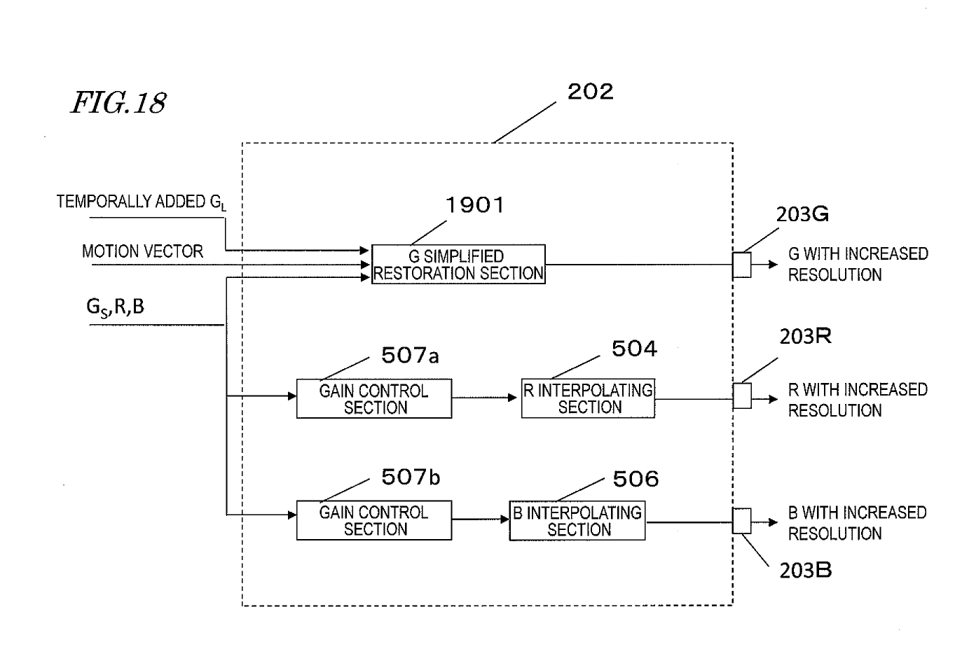

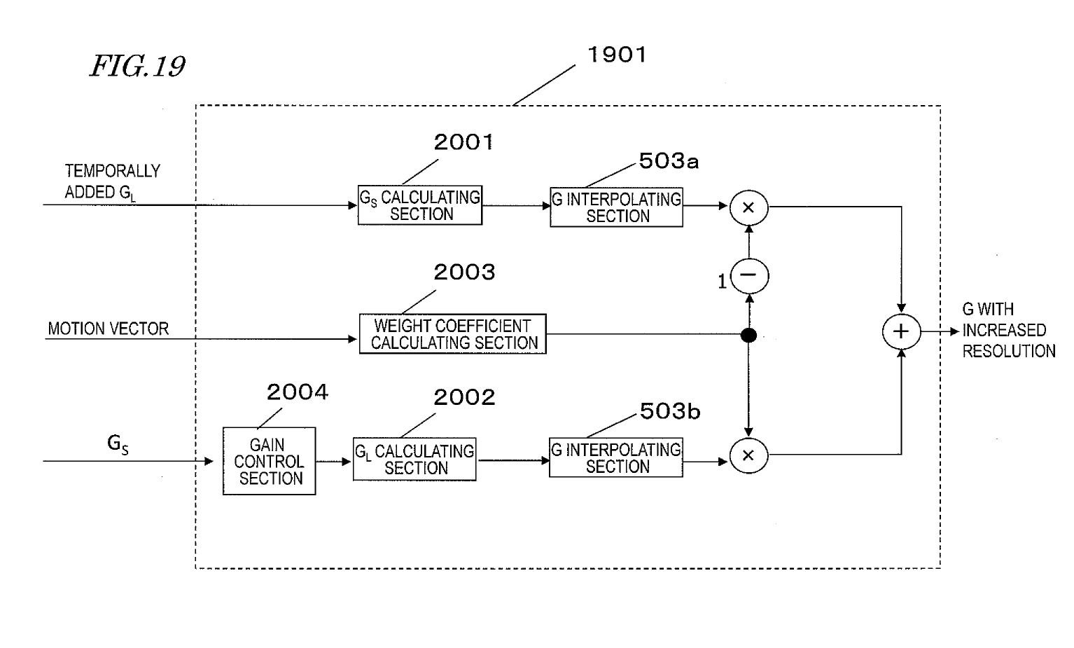

FIG. 19 illustrates a configuration for the G simplified restoration section 1901.

A weight coefficient calculating section 2003 receives a motion vector from the motion detecting section 201 (see FIG. 17). And by using the value of the motion vector received as an index, the weight coefficient calculating section 2003 outputs a corresponding weight coefficient.

A G_{S} calculating section 2001 receives the pixel value of G_{L} that has been subjected to the temporal addition and uses that pixel value to calculate the pixel value of G. A G interpolating section 503a receives the pixel value of G_{S} that has been calculated by the G_{S} calculating section 2001 and interpolates and expands the pixel value. That interpolated and expanded G_{S} pixel value is output from the G interpolating section 503a and then multiplied by an integral value of one minus the weight coefficient supplied from the weight coefficient calculating section 2003 (i.e., (1—weight coefficient value)).

Meanwhile, a G_{L} calculating section 2002 receives the pixel value of G_{S}, gets the gain of the pixel value increased by a gain control section 2004, and then uses that pixel value to calculate the pixel value of G_{L}. The gain control section 2004 decreases the difference between the luminance of G_{L} that has been subjected to an exposure process for a long time and that of G_{S} that has been subjected to an exposure process for a short time (which will be referred to herein as a “luminance difference”). If the longer exposure process has been performed for four frames, the gain control section 2004 may multiply the input pixel value by four in order to increase the gain. Next, a G interpolating section 503b receives the pixel value of G_{L} that has been calculated by the G_{L} calculating section 2002 and interpolates and expands the pixel value. That interpolated and expanded G_{L} pixel value is output from the G interpolating section 503b and then multiplied by the weight coefficient. Then, the G simplified restoration section 1901 adds together the two moving pictures that have been multiplied by the weight coefficient and outputs the sum.

Now take a look at FIG. 18 again. The gain control sections 507a and 507b have the function of increasing the gain of the pixel value received. This is done in order to narrow the luminance difference between the pixels (R, B) that have been subjected to an exposure process for a shorter time and the pixel G_{L} that has been subjected to the exposure process for a longer time. If the longer exposure process has been performed for four frames, the gain may be increased by multiplying the input pixel value by four.

It should be noted that the G interpolating sections 503a and 503b described above have only to have the function of interpolating and expanding the moving picture received. In this case, their interpolation and expansion processing may be carried out either by the same method or mutually different methods.

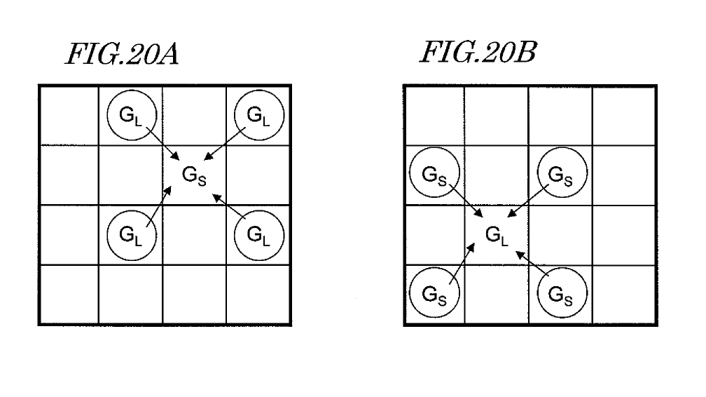

FIGS. 20A and 20B illustrate how the G_{S} and G_{L} calculating sections 2001 and 2002 may perform their processing. Specifically, FIG. 20A illustrates how the G_{S} calculating section 2001 calculates the value of a G_{S} pixel using the respective values of four G_{L} pixels that surround the G_{S} pixel. For example, the G_{S} calculating section 2001 may add together the respective values of the four G_{L} pixels and then divide the sum by an integral value of four. And the quotient thus obtained may be regarded as the value of the G_{S} pixel that is located at an equal distance from those four pixels.

On the other hand, FIG. 20B illustrates how the G_{L} restoring section 2002 calculates the value of a G_{L} pixel using the respective values of four G_{S} pixels that surround the G_{L} pixel. Just like the G_{S} calculating section 2001 described above, the G_{L} restoring section 2002 may add together the respective values of the four G_{S} pixels and then divide the sum by an integral value of four. And the quotient thus obtained may be regarded as the value of the G_{L} pixel that is located at an equal distance from those four pixels.

In the example described above, the values of four pixels that surround the target pixel, of which the pixel should be calculated, are supposed to be used. However, this is just an example of the present disclosure. Alternatively, some of the surrounding pixels, of which the values are close to each other, may be selectively used to calculate the value of the G_{S} or G_{L} pixel.

As described above, according to this second embodiment, by using the G simplified restoration section 1901, a moving picture that has had its frame rate and resolution both increased and its shakiness decreased can be restored with a lighter computational load than in the first embodiment described above.

### Embodiment 3

As for the first and second embodiments, it has been described how to calculate the value of every pixel on an RGB basis. On the other hand, in a method according to a third embodiment of the present disclosure to be described below, only a color pixel portion of a Bayer arrangement is calculated and then the Bayer restoration processing is carried out.

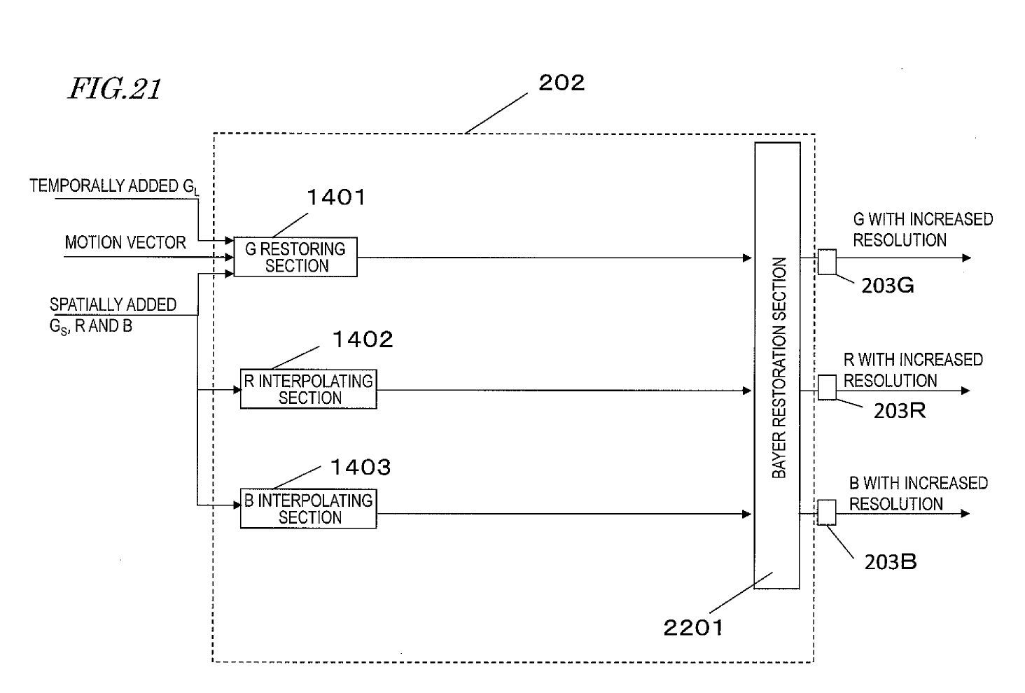

FIG. 21 illustrates a configuration in which a Bayer restoration section 2201 is added to the image quality improvement processing section 202 of the first embodiment described above. In FIGS. 4A and 4B, each of the G restoring section 501 and the R and B interpolating sections 504 and 506 calculates the pixel value of every pixel. In FIG. 21, on the other hand, each of the G restoring section 1401 and the R and B interpolating sections 1402 and 1403 makes calculation on only its associated pixel portions of the Bayer arrangement in the color allocated to itself. That is why if a G moving picture is supplied as an input value to the Bayer restoration section 2201, the G moving picture includes only the pixel values of G pixels in the Bayer arrangement. The R, G and B moving pictures are then processed by the Bayer restoration section 2201. As a result, each of the R, G and B moving pictures comes to have every pixel of its own interpolated with a pixel value.

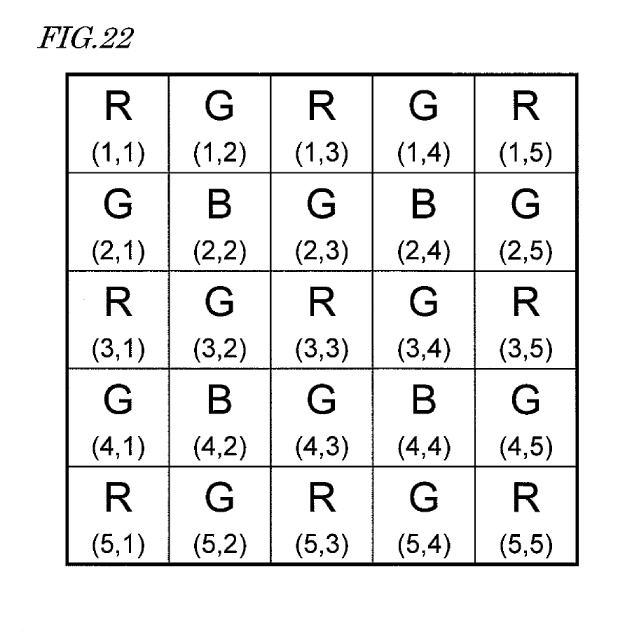

Based on the output of a single imager that uses color filters with the Bayer arrangement shown in FIG. 22, the Bayer restoration section 2201 calculates the RGB values of every pixel location. In the Bayer arrangement, a pixel location has information about only one of the three colors of RGB. Thus, the Bayer restoration section 2201 needs to obtain information about the other two colors by calculation. Several algorithms have been proposed so far for the Bayer restoration section 2201. In this description, the ACPI (adaptive color plane interpolation) method, which is often used generally, will be described as an example.

For example, as the pixel location (3, 3) shown in FIG. 22 is an R pixel, the pixel values of the other two colors B and G need to be calculated. According to the procedure of the ACPI method, an interpolated value of a G component with an intense luminance component is calculated first, and then a B or R interpolated value is calculated based on the G component interpolated value thus obtained. In this example, B and G interpolated values to calculate will be identified by B′ and G′, respectively. The Bayer restoration section 2201 may calculate a G′ (3, 3) value by the following Equation (51):

$${G}_{( 3 , 3 )}^{′} = \{ \begin{matrix}\frac{{G}_{( 2 , 3 )} + {G}_{( 4 , 3 )}}{2} + \frac{- {R}_{( 1 , 3 )} + 2 {R}_{( 3 , 3 )} - {R}_{( 5 , 3 )}}{4} & if α < β \\ \frac{{G}_{( 3 , 2 )} + {G}_{( 3 , 4 )}}{2} + \frac{- {R}_{( 3 , 1 )} + 2 {R}_{( 3 , 3 )} - {R}_{( 3 , 5 )}}{4} & if α > β \\ \frac{{G}_{( 2 , 3 )} + {G}_{( 4 , 3 )} + {G}_{( 3 , 2 )} + {G}_{( 3 , 4 )}}{4} + \frac{- {R}_{( 1 , 3 )} - {R}_{( 3 , 1 )} + 4 {R}_{( 3 , 3 )} - {R}_{( 3 , 5 )} - {R}_{( 5 , 3 )}}{8} & if α = β\end{matrix} \qquad ( 51 )$$

α and β in Equation (51) may be calculated by the following Equations (52):

α=|−R_{(1,3)}+2R_{(3,3)}−R_{(5,3)}|+|G_{(2,3)}−G_{(4,3)}|

β=|−R_{(3,1)}+2R_{(3,3)}−R_{(3,5)}|+|G_{(3,2)}−G_{(3,4)}| (52)

The Bayer restoration section 2201 may calculate a B′ (3, 3) value by the following Equation (53):

$${B}_{( 3 , 3 )}^{′} = \{ \begin{matrix}\frac{{B}_{( 2 , 4 )} + {B}_{( 4 , 2 )}}{2} + \frac{- {G}_{( 2 , 4 )}^{′} + 2 {G}_{( 3 , 3 )}^{′} - {G}_{( 4 , 2 )}^{′}}{4} & if {α}^{′} < {β}^{′} \\ \frac{{B}_{( 2 , 2 )} + {B}_{( 4 , 4 )}}{2} + \frac{- {G}_{( 2 , 2 )}^{′} + 2 {G}_{( 3 , 3 )}^{′} - {G}_{( 4 , 4 )}^{′}}{4} & if {α}^{′} > {β}^{′} \\ \frac{{B}_{( 2 , 4 )} + {B}_{( 4 , 2 )} + {B}_{( 2 , 2 )} + {B}_{( 4 , 4 )}}{4} + \frac{- {G}_{( 2 , 2 )}^{′} - {G}_{( 2 , 4 )}^{′} + 4 {G}_{( 3 , 3 )}^{′} - {G}_{( 4 , 2 )}^{′} - {G}_{( 4 , 4 )}^{′}}{8} & if {α}^{′} = {β}^{′}\end{matrix} \qquad ( 53 )$$

α and β in Equation (53) may be calculated by the following Equations (54):

α′=|−G′_{(2,4)}+2G′_{(3,3)}−G′_{(5,3)}|+|B_{(2,3)}−B_{(4,3)}|

β′=|−G′_{(3,1)}+2G′_{(3,3)}−G′_{(3,5)}|+|B_{(3,2)}−B_{(3,4)}| (54)

In another example, R′ and B′ values at a G pixel location (2, 3) in the Bayer arrangement may be calculated by the following Equations (55) and (56), respectively:

$$\begin{matrix}{R}_{( 2 , 3 )} = \frac{{R}_{( 1 , 3 )} + {R}_{( 3 , 3 )}}{2} + \frac{- {G}_{( 1 , 3 )}^{′} + 2 {G}_{( 2 , 3 )}^{′} - {G}_{( 3 , 3 )}^{′}}{4} & ( 55 ) \\ {B}_{( 2 , 3 )} = \frac{{B}_{( 2 , 2 )} + {B}_{( 2 , 4 )}}{2} + \frac{- {G}_{( 2 , 2 )}^{′} + 2 {G}_{( 2 , 3 )}^{′} - {G}_{( 2 , 4 )}^{′}}{4} & ( 56 )\end{matrix}$$

In the example described above, the Bayer restoration section 2201 is supposed to adopt the ACPI method. However, this is only an example of the present disclosure. Alternatively, RGB values of every pixel location may also be calculated by a method that takes the hue into account or an interpolation method that uses a median.

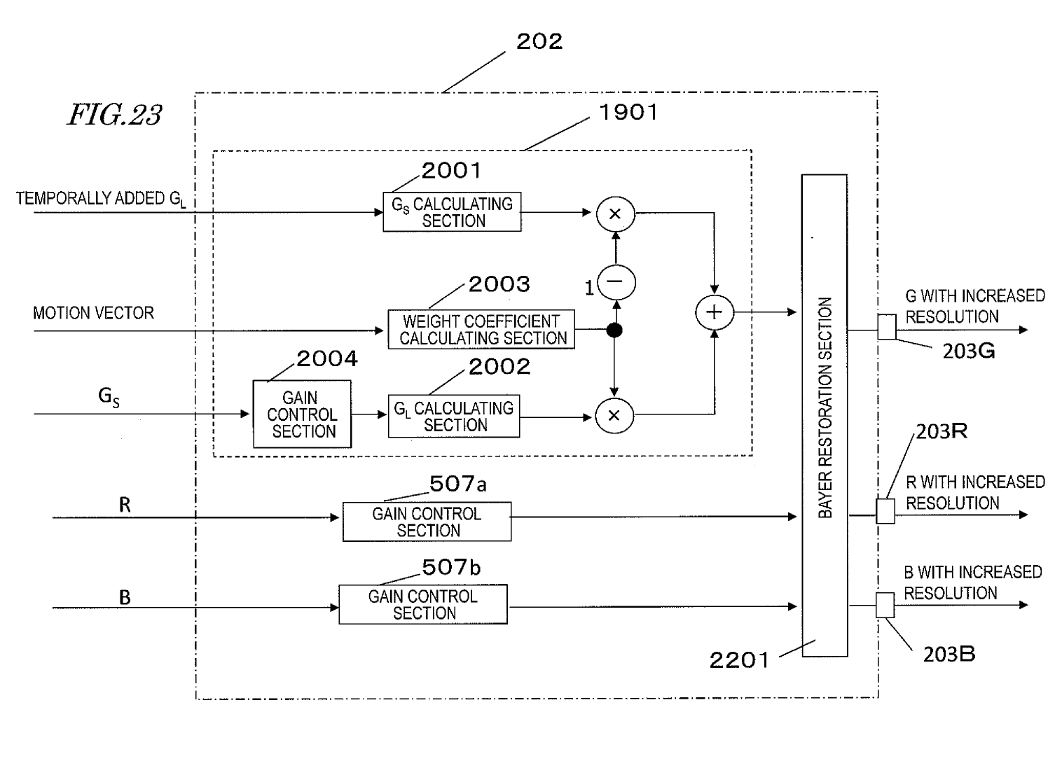

FIG. 23 illustrates a configuration in which the Bayer restoration section 2201 is further added to the image quality improvement processing section 202 of the second embodiment. In the second embodiment described above, the image quality improving section 105 includes the G, R and B interpolating sections 503, 504 and 506. On the other hand, according to this embodiment, the G, R and B interpolating sections 503, 504 and 506 are omitted and only pixel portions of the Bayer arrangement in the allocated color are subjected to calculations. That is why if a G moving picture is supplied as an input value to the Bayer restoration section 2201, only G pixels of the Bayer arrangement have pixel values. The R, G and B moving pictures are processed by the Bayer restoration section 2201. As a result, each of the R, G and B moving pictures comes to have the value of every pixel thereof interpolated. In the second embodiment described above, after G_{S} and G_{L} have been interpolated, all G pixels are interpolated and then multiplied by a weight coefficient. However, by using the Bayer restoration, the interpolation processing needs to be carried out only once, not twice, on all G pixels.

The Bayer restoration processing adopted in this example refers to an existent interpolating method for use to reproduce colors using Bayer arrangement filters.

As described above, by adopting the Bayer restoration, color shifting or smearing can be reduced according to this third embodiment compared to a situation where pixels are just interpolated and expanded. Consequently, the computational load can be reduced compared to the second embodiment described above.

### Embodiment 4

In the first embodiment described above, the number of pixels to be added together spatially with respect to R, B and G_{S} and the number of pixels to be added together temporally with respect to G_{L} are supposed to be determined in advance.

In a fourth embodiment of the present disclosure to be described below, however, the number of pixels to be added together is controlled according to the amount of light entering a camera.

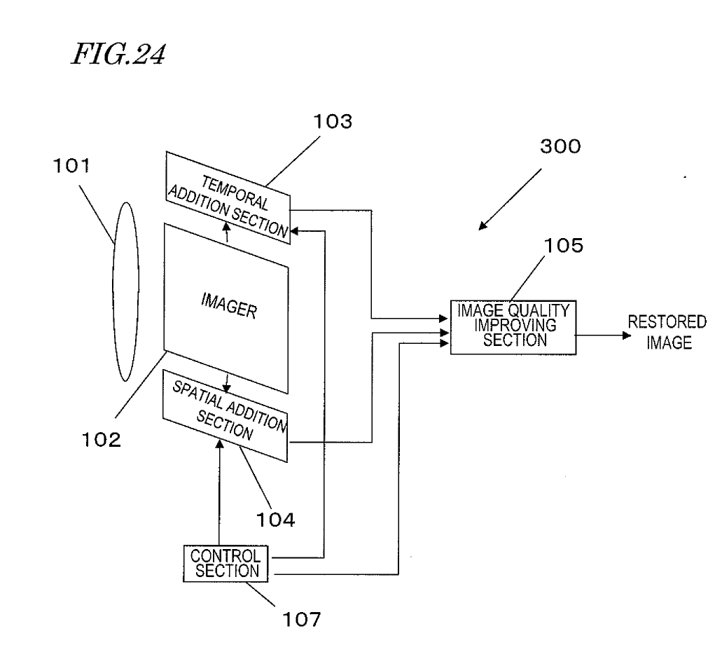

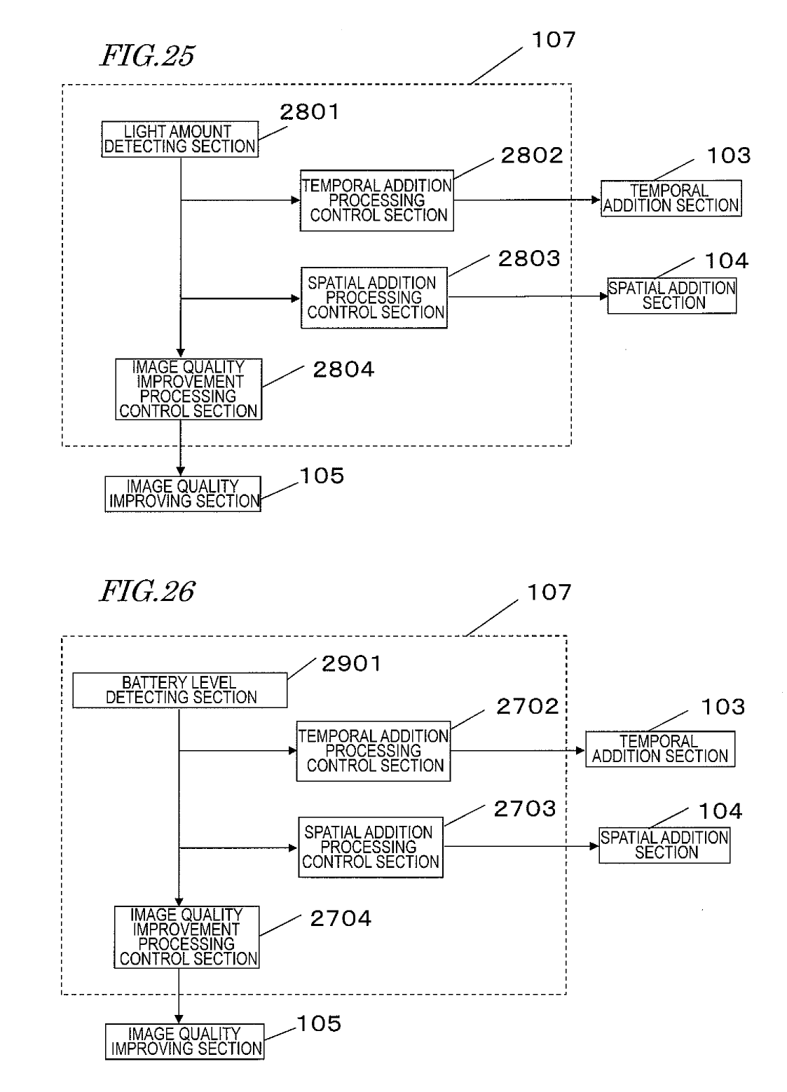

FIG. 24 illustrates a configuration for an image capturing processor 300 according to this fourth embodiment. In FIG. 24, any component that operates in the same way as its counterpart shown in FIG. 1 is identified by the same reference numeral and its description will be omitted herein. Hereinafter, it will be described with reference to FIG. 25 how the control section 107 works.

FIG. 25 illustrates a configuration for the control section 107 of this embodiment.

The control section 107 includes a light amount detecting section 2801, a temporal addition processing control section 2802, a spatial addition processing control section 2803 and a image quality improvement processing control section 2804.

According to the amount of the incident light, the control section 107 changes the number of pixels to be added together by the temporal and spatial addition sections 103 and 104.

The amount of the incident light is sensed by the light amount detecting section 2801. In this case, the light amount detecting section 2801 may measure the amount of the light either by calculating the total average or color-by-color averages of the read signals supplied from the imager 102 or by using the signal that has been obtained by temporal addition or spatial addition. Alternatively, the light amount detecting section 2801 may also measure the amount of light based on the luminance level of the moving picture that has been restored by the image restoration section 105. Still alternatively, the light amount detecting section 2801 may even get the amount of light measured by a photoelectric sensor, which is separately provided in order to output an amount of current corresponding to the amount of light received.

If the light amount detecting section 2801 has sensed that the amount of the incident light is sufficient (e.g., equal to or greater than a half of the saturation level), the control section 107 performs a control operation so that every pixel will be read per frame without performing addition or reading. Specifically, the temporal addition processing control section 2802 instructs the temporal addition section 103 not to perform the temporal addition, and the spatial addition processing control section 2803 instructs the spatial addition section 104 not to perform the spatial addition. Meanwhile, the image quality improvement processing control section 2804 controls the image quality improving section 105 so that only the Bayer restoration section 2201 performs its operation on the RGB values supplied.

On the other hand, if the light amount detecting section 2801 has sensed that the amount of the incident light is insufficient and has decreased to a half, a third, a quarter, a sixth or a ninth of the saturation level, then the temporal and spatial addition processing control sections 2802 and 2803 perform their control operation by increasing the number of frames to be subjected to the temporal addition by the temporal addition section 103 and the number of pixels to be spatially added together by the spatial addition section 104 two-, three-, four-, six- or nine-fold. Meanwhile, the image quality improvement processing control section 2804 controls the contents of the processing to be performed by the image quality improving section 105 according to the number of frames for temporal addition that has been changed by the temporal addition processing control section 2802 or the number of pixels to be spatially added together that has been changed by the spatial addition processing control section 2803.

In this manner, the modes of addition processing can be changed according to the amount of the incident light that has entered the camera. As a result, the processing can be carried out seamlessly according to the amount of the incident light, i.e., irrespective of the amount of the incident light that could vary from only a small amount through a large amount. Consequently, the image can be captured with the dynamic range expanded and with the saturation reduced.

Naturally, the number of pixels to be added together is not necessarily controlled with respect to the whole moving picture but may also be changed adaptively on a pixel location or pixel region basis.

Also, as can be seen easily from the foregoing description, the control section 7 may also operate so as to change the modes of addition processing according to the pixel value, instead of the amount of the incident light. Still alternatively, the modes of addition processing may also be switched by changing the modes of operation in accordance with the user's instruction.

### Embodiment 5

The fourth embodiment of the present disclosure described above is applied to a situation where the numbers of R, G and B pixels to be added together are controlled according to the amount of the light that has come from the subject.

On the other hand, an image capturing processor as a fifth embodiment of the present disclosure can operate with an equipped power source (i.e., a battery) and controls the number of R, G and B pixels to be added together according to the battery level. This image capturing processor may also have the configuration shown in FIG. 24, for example.

FIG. 26 illustrates a configuration for the control section 107 of the image capturing processor according to this embodiment.

The control section 107 includes a battery level detecting section 2901, a temporal addition processing control section 2702, a spatial addition processing control section 2703, and an image quality improvement processing control section 2704.

If the battery level is low, then the consumption of the battery needs to be reduced. And the consumption of the battery can be cut down by lightening the computational load, for example. That is why according to this embodiment, if the battery level is low, then the computational load on the image quality improving section 105 is supposed to be lightened.

The battery level detecting section 2901 monitors the level of the battery of the image capture device by detecting a voltage value representing the battery level, for example. Recently, some batteries may have their own battery level sensing mechanism. And if such a battery is used, then the battery level detecting section 2901 may also get information about the battery level by communicating with that battery level sensing mechanism.

If the battery level has turned out to be less than a predetermined reference value, the control section 107 gets every pixel read per frame without performing the addition reading. Specifically, the temporal addition processing control section 2802 instructs the temporal addition section 103 not to perform the temporal addition, and the spatial addition processing control section 2803 instructs the spatial addition section 104 not to perform the spatial addition. Meanwhile, the image quality improvement processing control section 2804 controls the image quality improving section 105 so that only the Bayer restoration section 2201 performs its operation on the RGB values supplied.

On the other hand, if the battery level has turned out to be equal to or greater than the reference value (i.e., if the battery has got plenty of power left), then the processing of the first embodiment may be carried out.

If the battery level is low, the computational load on the image quality improving section 105 can be reduced. Then, the consumption of the battery can be cut down and more subjects can be shot over a longer period of time.

In this fifth embodiment, every pixel is supposed to be read if the battery level is low. However, the resolution of R, G and B moving pictures may be increased by the method that has already been described for the second embodiment.

### Embodiment 6

The processing of controlling the number of pixels to be added together for the R, G and B moving pictures according to the battery level of the image capture device has just been described as the fifth embodiment.

Meanwhile, an image capturing processor as this sixth embodiment of the present disclosure controls the image quality improving section 105 according to the magnitude of motion of the subject. The image capturing processor may also have the configuration shown in FIG. 24, for example.

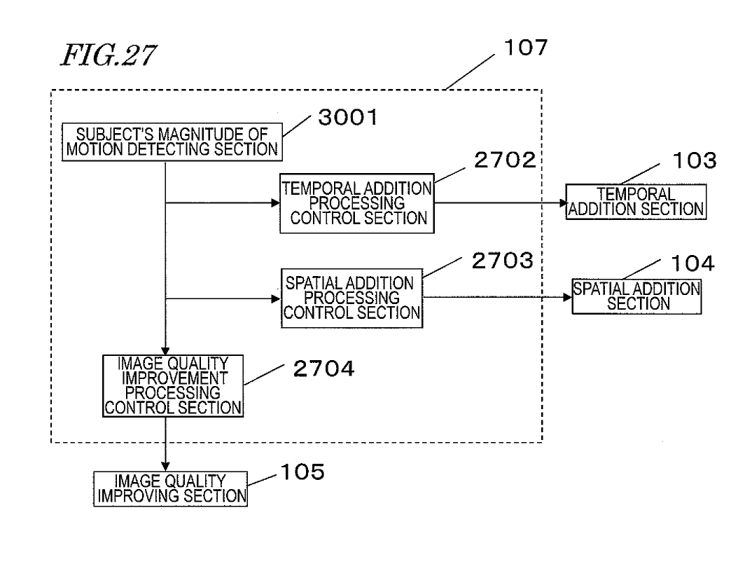

FIG. 27 illustrates a configuration for the control section 107 of the image capturing processor of this embodiment.

The control section 107 includes a subject's magnitude of motion detecting section 3001, a temporal addition processing control section 2702, a spatial addition processing control section 2703 and a image quality improvement processing control section 2704.

The subject's magnitude of motion detecting section 3001 detects the magnitude of motion of the subject. The method of detection may be the same as the motion vector detecting method used by the motion detecting section 201 (see FIG. 2). The subject's magnitude of motion detecting section 3001 may detect the magnitude of motion by the block matching method, the gradient method or the phase correlation method. By seeing if the magnitude of motion detected is less than or equal to or greater than a predetermined reference value, the subject's magnitude of motion detecting section 3001 can determine whether the magnitude of motion is significant or not.

If the magnitude of motion has turned out to be insignificant due to the lack of the amount of light, the spatial addition processing control section 2703 instructs the spatial addition section 104 to make spatial addition with respect to R and B moving pictures. On the other hand, the temporal addition processing control section 2702 controls the temporal addition section 103 so that temporal addition is carried out for every part of the G moving picture. Then, the image quality improvement processing control section 2704 instructs the image quality improving section 105 to perform the same restoration processing as what is disclosed in Japanese Laid-Open Patent Publication No. 2009-105992 and outputs R, G and B moving pictures with increased resolutions. As for G, every part of it is supposed to be subjected to the temporal addition. This is because as the subject's motion is small, the G moving picture will be less affected by the motion or shift involved by carrying out the exposure process for a long time, and therefore, a G moving picture can be shot with high sensitivity and high resolution.

On the other hand, if the subject has turned out to be dark and have a significant magnitude of motion, R, G and B moving pictures with increased resolutions are output by the method that has already been described for the first embodiment.

In this manner, the contents of processing to be carried out by the image quality improving section 105 can be changed according to the magnitude of motion of the subject. As a result, a moving picture of high image quality can be generated according to the subject's motion.

### Embodiment 7

In the embodiments described above, the temporal addition section 103, the spatial addition section 104 and the image quality improving section 105 are supposed to be controlled according to the function incorporated in the image capturing processor.

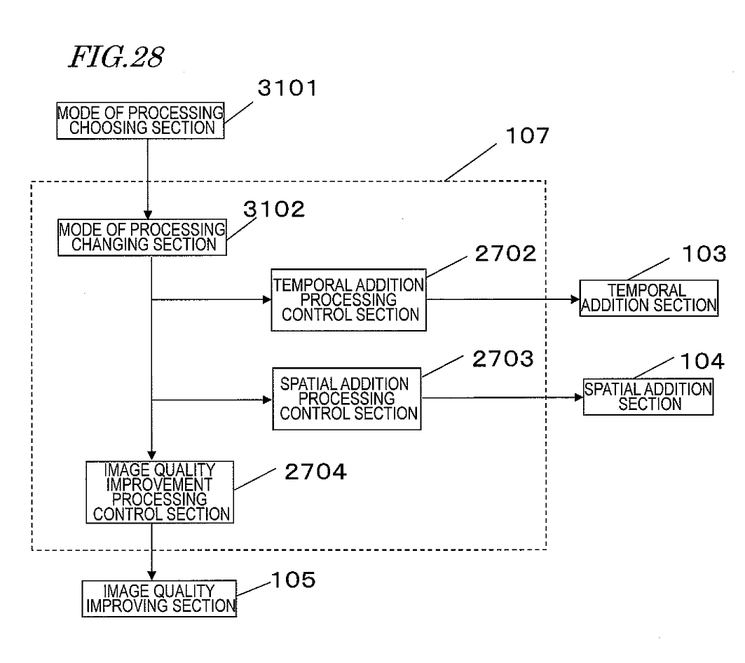

On the other hand, according to this seventh embodiment of the present disclosure, the user who is operating the image capturing processor can choose any image capturing method he or she likes. Hereinafter, it will be described with reference to FIG. 28 how the control section 107 operates.

FIG. 28 illustrates a configuration for the control section 107 of an image capturing processor according to this embodiment.

Using a mode of processing choosing section 3101, which is provided outside of the control section 107, the user can choose an image capturing method. The mode of processing choosing section 3101 is a piece of hardware that is provided for the image capturing processor and that may be implemented as a dial switch that allows the user to choose any image capturing method he or she likes. Alternatively, the mode of processing choosing section 3101 may also be a menu for choice to be displayed by a software program on an LCD panel (not shown) provided for the image capturing processor.

The mode of processing choosing section 3101 notifies a mode of processing changing section 3102 of the image capturing method that the user has chosen. In response, the mode of processing changing section 3102 gives instructions to the temporal addition processing control section 2702, the spatial addition processing control section 2703, and the image quality improvement processing control section 2704 so that the image capturing method chosen by the user is carried out.

In this manner, any mode of image capturing processing can be carried out according to the user's preference.

Various configurations for the control section 107 have been described for the fourth through seventh embodiments. However, the control section 107 may also have two or more of those functions in combination.

Various embodiments of the present disclosure have been described in the foregoing description.

In the first through third embodiments described above, RGB color filters in the three primary colors are supposed to be used to form an array of color filters for use to capture an image. However, the array of color filters is not necessarily made up of those color filters. For example, CMY (cyan, magenta and yellow) color filters in complementary colors may also be used. As far as the amount of light is concerned, the CMY filters can obtain roughly twice as much light as the RGB filters do. Thus, if color reproducibility is given a top priority, for example, the RGB filters may be used. On the other hand, if the amount of light obtained should be as much as possible, then the CMY filters may be used.

Also, in the various embodiments of the present disclosure described above, the pixel values obtained by temporal addition and spatial addition using multiple different color filters (i.e., the pixel values subjected to the temporal addition and then the spatial addition, which correspond to the amount of light) should naturally have as broad a color range as possible. For example, in the first embodiment described above, if the spatial addition is carried out on two pixels, the temporal addition is performed on two frames. On the other hand, if the spatial addition is carried out on four pixels, the temporal addition is performed on four frames. In this manner, it is preferred that the number of frames to be subjected to the temporal addition, for example, be equalized in advance with the number of pixels.

Meanwhile, in a special situation where the subject's color has shifted toward a particular color, if filters in primary colors are used, for example, the number of pixels to be subjected to the temporal and spatial additions may be changed adaptively for the R, G and B moving pictures. Then, the dynamic range can be used effectively on a color-by-color basis.

In the various embodiments of the present disclosure described above, a single imager is supposed to be used as the imager 102 and color filters with the arrangement shown in FIGS. 4A and 4B are used as an example. However, the color filters do not always have to be arranged as shown in FIGS. 4A and 4B.

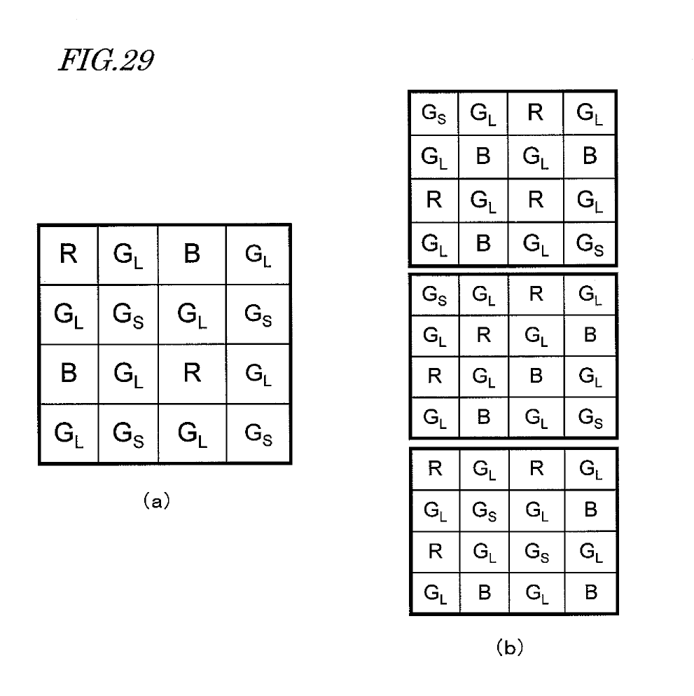

For instance, the arrangement of color filters shown in FIG. 29 may also be used. FIG. 29(a) illustrates an example in which a single imager is combined with color filters that are arranged differently from their counterparts shown in FIGS. 4A and 4B. The ratio of the numbers of pixels to generate R, G_{L}, G_{S} and B pixel signals may be R, G_{L}, G_{S}:B=1:4:2:1.

On the other hand, FIG. 29(b) illustrates an example in which the pixel number ratio consists of a different combination of numbers from in the example shown in FIG. 29(a). Specifically, in this example, R, G_{L}, G_{S}:B=3:8:2:3.

According to the present disclosure, the single imager 102 does not always have to be used. But the present disclosure can also be carried out using three imagers that generate R, G and B pixel signals separately from each other (i.e., so-called “three imagers”).

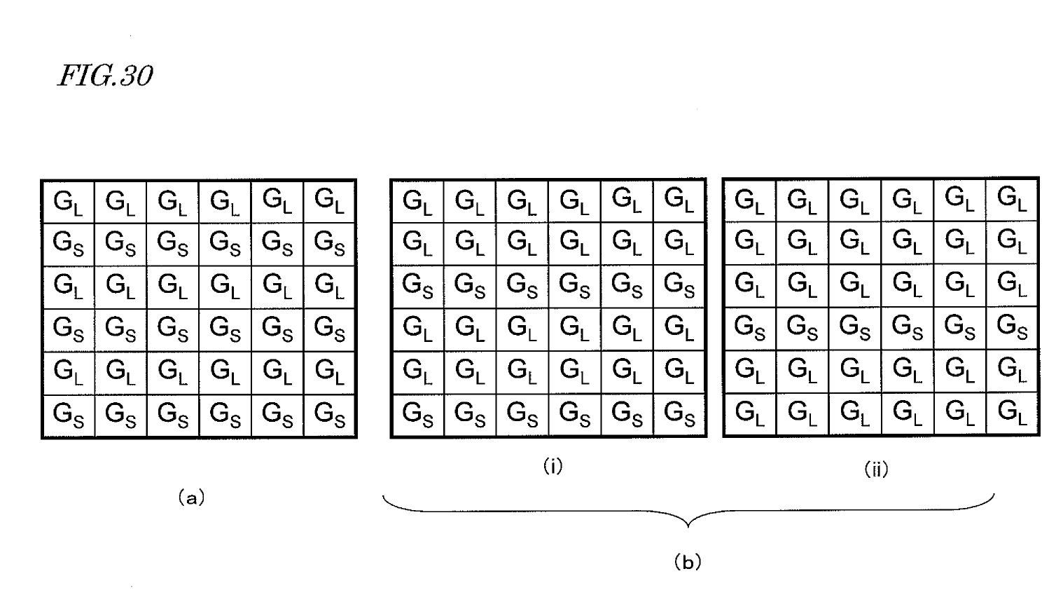

For example, FIGS. 30(a) and 30(b) each illustrate a configuration for an imager that generates G (i.e., G_{L} and G_{S}) pixel signals. Specifically, FIG. 30(a) illustrates an exemplary configuration to use when G_{L} and G_{S} have the same number of pixels. On the other hand, FIG. 30(b) illustrates a situation where the number of pixels of G_{L} is greater than that of G_{S}. In FIG. 30(b), portion (i) illustrates an exemplary configuration to use when the ratio of the numbers of pixels of G_{L} and G_{S} is 2:1, while portion (ii) illustrates an exemplary configuration to use when the ratio of the numbers of pixels of G_{L} and G_{S} is 5:1. The imager for generating the R and B pixel signals needs to be provided with filters that transmit only R and B rays, respectively.

As in the respective examples shown in FIG. 30, G_{L} and G_{S} elements may alternate with each other one line after another. If the exposure time is changed on a line-by-line basis, the same read signal is obtained from the circuit on each line. That is why the configuration of the circuit can be simplified compared to a situation where the exposure time of the sensor is changed in a lattice pattern.

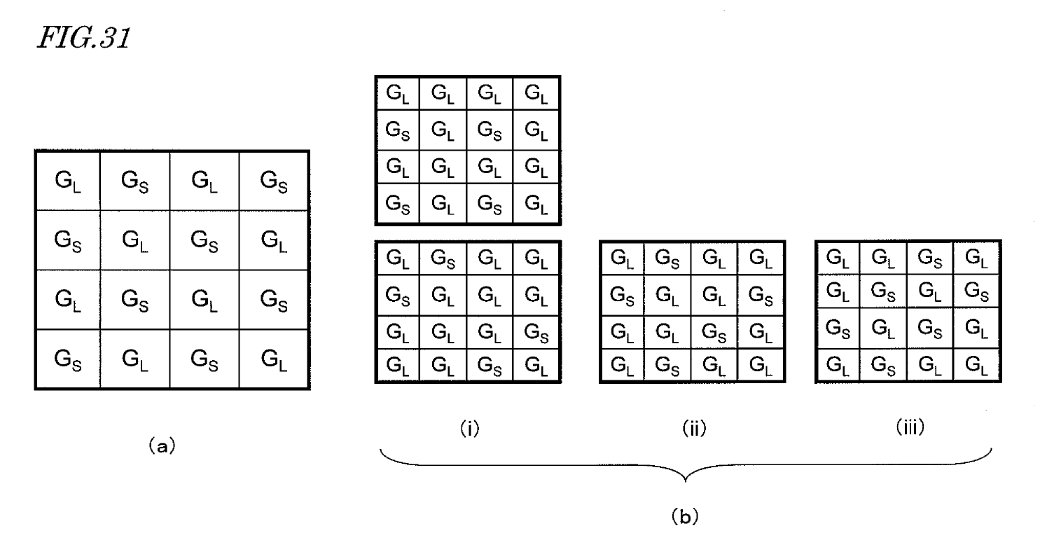

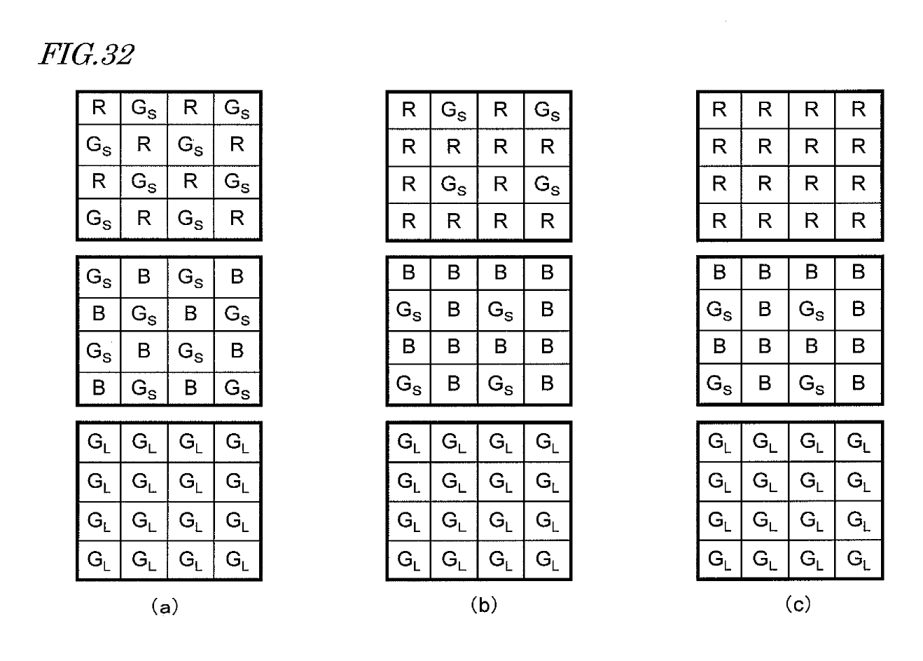

Alternatively, the exposure time may also be changed by using variations of 4×4 pixels as shown in FIG. 31, not on a line-by-line basis as shown in FIG. 30. Specifically, FIG. 31(a) illustrates an exemplary configuration in which the number of pixels of G_{L} is as large as that of G_{S}, while FIG. 31(b) illustrates exemplary configurations in which the number of pixels of G_{L} is larger than that of pixels of G_{S}. Portions (i), (ii) and (iii) of FIG. 31(b) illustrate three different configurations in which the ratio of the number of pixels of G_{L} to that of pixels of G_{S} is 3:1, 11:5 and 5:3, respectively. The variations are not just the ones shown in FIGS. 30 and 31 but also the ones shown in FIGS. 32(a) through 32(c) in which G_{S} color filters are included in each set consisting mostly of R and B color filters. FIGS. 32(a), 32(b) and 32(c) illustrate exemplary configurations in which the ratio of the number of pixels of R, G_{L}, G_{S} and B is 1:2:2:1, 3:4:2:3, and 4:4:1:3, respectively.

It should be noted that both a single imager and three imagers will sometimes be collectively referred to herein as an “image capturing section”. That is to say, in an embodiment in which a single imager is used, the image capturing section means the imager itself. On the other hand, in an embodiment in which three imagers are used, the three imagers are collectively referred to herein as the “image capturing section”.

In the various embodiments of the present disclosure described above, when pixels are spatially added together to generate R or B or when an exposure process is performed for a long time to generate G, the spatial addition or the long exposure process may get done through signal processing by reading out every pixel of RGB through a short exposure process before the image processing. Examples of such signal processing computations include adding those pixel values together and calculating their average. However, these are only examples. Optionally, the four arithmetic operations may be performed in combination by using coefficients, of which the values vary with the pixel value. In that case, the conventional imager may be used and the SNR can be increased through the image processing.

Furthermore, in the various embodiments of the present disclosure described above, the temporal addition may be carried out on only G_{L} without performing the spatial addition on R, B or G_{S}. If the temporal addition is carried out on only G_{L}, there is no need to perform image processing on R, B or G. Consequently, the computational load can be cut down.

<Spectral Characteristics of Filters>

As described above, according to the present disclosure, either a single imager or three imagers may be used. It should be noted, however, that thin-film optical filters for use in three imagers and a dye filter for use in a single imager are known to have mutually different spectral characteristics.

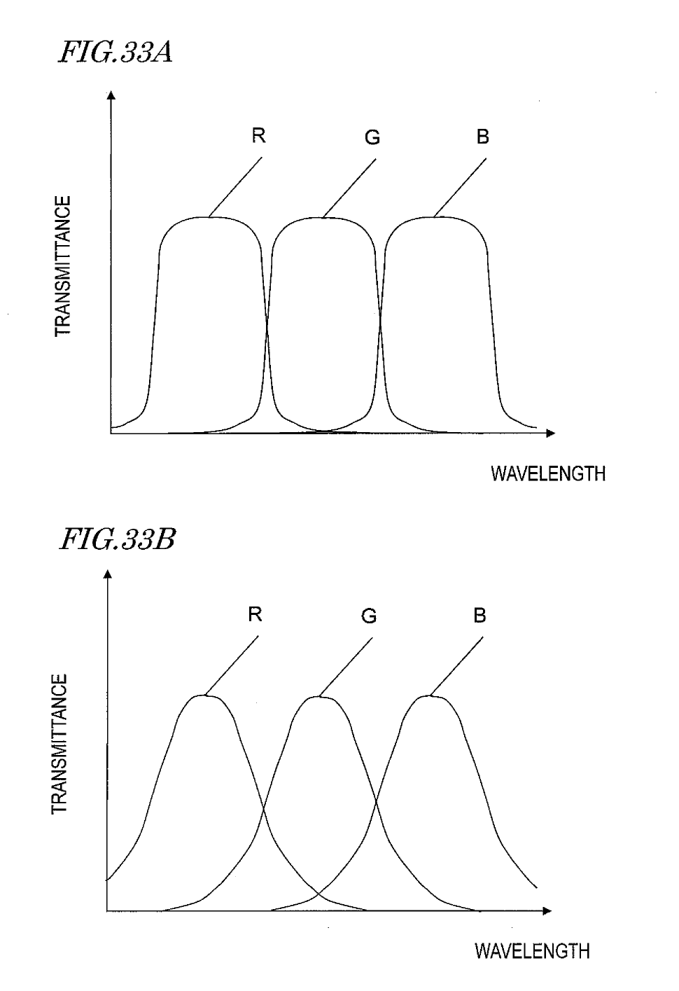

FIG. 33A shows the spectral characteristics of thin-film optical filters for three imagers, while FIG. 33B shows the spectral characteristic of a dye filter for a single imager.

As for the spectral characteristics of the thin-film optical filters shown in FIG. 33A, the transmittance rises more steeply, and overlaps less between the RGB characteristics, than that of the dye filter. On the other hand, as for the dye filter, the transmittance rises more gently, and overlaps more between the RGB characteristics, than that of the thin-film optical filters as shown in FIG. 33B.

In the various embodiments of the present disclosure described above, the temporally added G moving picture is decomposed both temporally and spatially by reference to the motion information that has been detected from the R and B moving pictures. That is why in order to process the G moving picture smoothly, it is preferred that G information be included in R and B moving pictures as in the dye filter.

<Correction to Focal Plane Phenomenon>

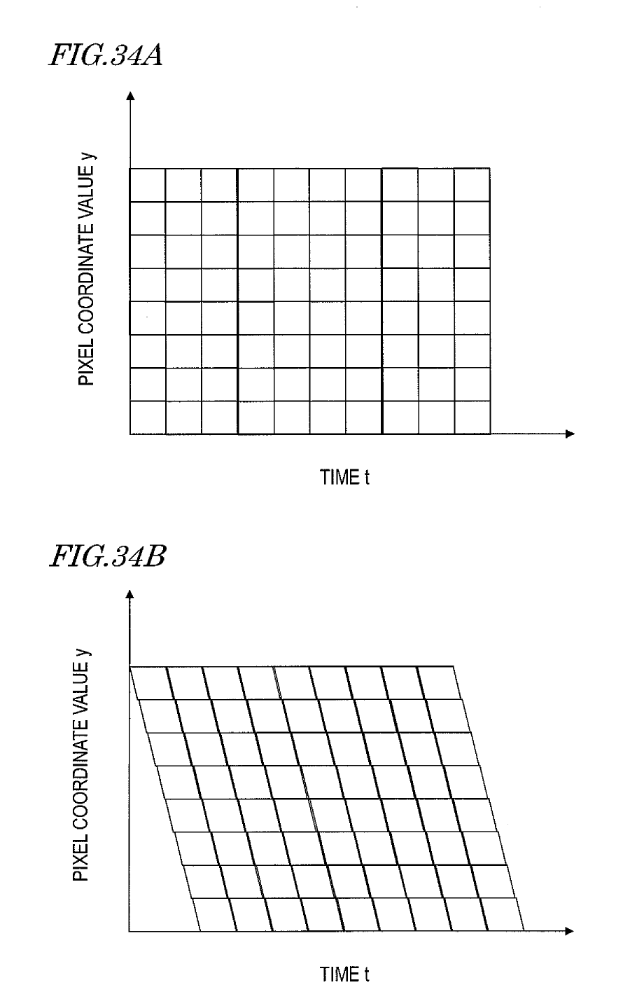

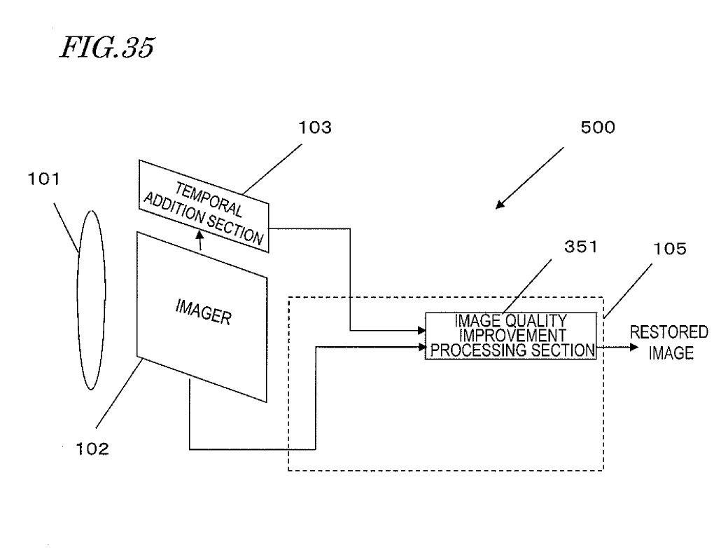

In any of the various embodiments of the present disclosure described above, shooting is supposed to be done using a global shutter. In this description, the “global shutter” refers to a shutter that starts and ends the exposure process at the same time for respective color-by-color pixels in one frame image. For example, FIG. 34A shows the timings of an exposure process that uses such a global shutter.

However, the present disclosure is in no way limited to such a specific preferred embodiment. For example, even if a focal plane phenomenon, which often raises a problem when shooting is done with a CMOS imager, happens as shown in FIG. 34B, a moving picture that has been shot with a global shutter can also be restored by formulating the mutually different exposure timings of the respective sensors.

Although various embodiments of the present disclosure have been described, each of those embodiments is just an example and could be modified in numerous ways. Thus, a modified example of the second embodiment will be described first, and then modified examples of the other embodiments will follow it.

As for the first embodiment described above, the processing by the image quality improving section 105 is supposed to be done in most cases by using all of a degradation constraint, a motion constraint that uses motion detection, and a smoothness constraint on the distribution of pixel values. On the other hand, the second embodiment described above is a method for generating a moving picture that has a high resolution, a high frame rate and little shakiness due to motion with a lighter computational load than in the first embodiment by using the G simplified restoration section 1901 when no spatial addition is done on G_{S}, R or B.

Thus, a method for generating a moving picture that also has a high resolution, a high frame rate and little shakiness due to motion by using the same image quality improving section as its counterpart of the first embodiment when no spatial addition is done on G_{S}, R or B will be described as a modified example.

Among various constraints imposed on the image quality improving section, to meet the motion constraint, the computational load will be particularly heavy and a lot of computer resources of the device will have to be consumed. Thus, the modified example to be described below is processing that does not use the motion constraint among these constraints.

FIG. 35 is a block diagram illustrating a configuration for an image capturing processor 500 that includes an image processing section 105 with no motion detecting section 201. The image quality improvement processing section 351 of the image processing section 105 generates a new picture without using the motion constraint.

In FIG. 35, any component also shown in FIG. 1, 2, or 17 and having substantially the same function as its counterpart is identified by the same reference numeral as the one used in FIG. 1, 2 or 17 and description thereof will be omitted herein.

According to conventional technologies, if the motion constraint were not used, then the image quality would be debased appreciably as a result of the processing.

However, according to the present disclosure, the motion constraint can be omitted without debasing the image quality significantly. The reason is that in the single color imager 102, respective pixels to be subjected to the long exposure process and pixels to be subjected to the short exposure process include pixels from which multiple color components will be detected. In each of the color channels of RGB, pixels that have been obtained through shooting with the short exposure process and pixels that have been obtained through shooting with the long exposure process are included in the same mixture. That is why even if an image is generated without using the motion constraint, the values of those pixels that have been obtained through shooting with the short exposure process can minimize the color smearing. On top of that, since a new moving picture is generated without imposing the motion constraint, the computational load can be cut down as well.

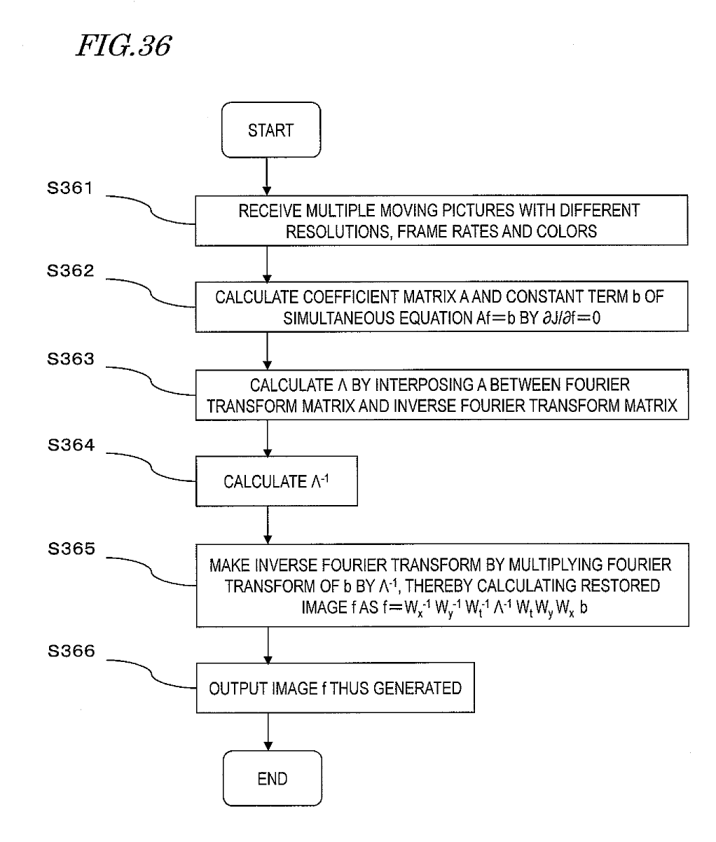

Hereinafter, it will be described how the image quality improvement processing section 351 performs the image quality improvement processing. FIG. 36 is a flowchart showing the procedure of the image quality improvement processing to be carried out by the image quality improving section 105.

First of all, in Step S361, the image quality improvement processing section 351 receives multiple moving pictures, which have mutually different resolutions, frame rates and colors, from the imager 102 and the temporal addition section 103.

Next, in Step S362, the image quality improvement processing section 351 sets M in Equation (4) to be two, uses either Equation (12) or Equation (13) as Q, and sets m in those equations to be two. And if one of Equations (14), (15) and (16) is used to expand the differences of the first-order and second-order differentiations or if P is set to be two in Equation (40), then the evaluation equation J becomes the quadratic of f. According to the following Equation (57), to calculate f that minimizes the evaluation equation can be reduced to calculating a simultaneous equation with respect to f:

$$\frac{\partial J}{\partial f} = 0 \qquad ( 57 )$$

In this case, the simultaneous equation to solve is supposed to be represented by the following Equation (58):

Af=b (58)

In Equation (58), f has as many elements as the pixels to generate (which is obtained by number of pixels per frame×number of frames to process). That is why the computational load imposed by Equation (58) is usually an enormous one. As a method for solving such a large scale simultaneous equation, a method for converging the solution f by performing iterative calculations by the conjugate gradient method or the steepest descent method is usually adopted.

If f is calculated without using the motion constraint, then the evaluation function will consist of only a degradation constraint term and a smoothness constraint term, and therefore, the processing will not depend on the type of the content anymore. And by taking advantage of this, the inverse matrix of the coefficient matrix A of the simultaneous equation (i.e., Equation (54)) can be calculated in advance. And by using that inverse matrix, image processing can be carried out by the direct method.

Next, the processing step S263 will be described. If the smoothness constraint represented by Equation (13) is used, the second-order partial differentiation of x and y becomes a filter that has the three coefficients 1, −2 and 1 as given by Equation (14), for example, and its square becomes a filter that has the five coefficients 1, −4, 6, −4 and 1. These coefficients can be diagonalized by interposing the coefficient matrix between horizontal and orthogonal Fourier transforms and their inverse transforms. Likewise, the long exposure degradation constraint can also be diagonalized by interposing the coefficient matrix between the temporal Fourier transform and the inverse Fourier transform. That is to say, the image quality improvement processing section 351 can represent the matrix Λ as in the following Equation (59):

Λ=WₜW_{y}WₓAWₓ⁻¹W_{y}⁻¹Wₜ⁻¹ (59)

As a result, the number of non-zero coefficients per row can be reduced compared to the coefficient matrix A. Consequently, in Step S364, the inverse matrix Λ⁻¹ of Λ can be calculated more easily. In Step S365, based on Equations (56) and (57), the image quality improvement processing section 351 can obtain f with the computational load and circuit scale both reduced and without making iterative computations.

WₜW_{y}WₓAWₓ⁻¹W_{y}⁻¹Wₜ⁻¹WₜW_{y}Wₓf=ΛWₜW_{y}Wₓf=WₜW_{y}Wₓb (60)

f=Wₓ⁻¹W_{y}⁻¹Wₜ⁻¹Λ⁻¹WₜW_{y}Wₓb=A⁻¹b (61)

And in Step S366, the image quality improvement processing section 351 outputs the restored image f that has been calculated in this manner.

By adopting the configuration and procedure described above, according to this modified example, when a moving picture with a high resolution, a high frame rate and little shakiness due to motion is going to be generated by using the same image quality improvement processing section as that of the first embodiment without performing spatial addition on G_{S}, R and B, the moving picture can be generated with the computational load reduced and without imposing the motion constraint or performing motion detection to meet the motion constraint.

In the various embodiments of the present disclosure described above, processing is supposed to be performed using the four kinds of moving pictures G_{L}, G_{S}, and B. However, this is just an example of the present disclosure. For example, if the subject to shoot consists mostly of the color green, a new moving picture may also be generated using only two kinds of moving pictures G_{L} and G_{S}. Meanwhile, if the subject to shoot consists mostly of colors other than B or R, then a new moving picture may also be generated using only three kinds of moving pictures R or B, G_{L}, and G_{S}.

The image capturing processor of this embodiment and the image capturing processor of its modified example capture G separately as G_{L} and G₅. However, this is only an example of the present disclosure and any other method may also be adopted.

However, if it is known in advance that the image to be captured would have a lot of B components (e.g., in a scene where the image should be captured under sea water or in a swimming pool), then B moving pictures may be captured through the long and short exposure processes and R and G images may be captured with a low resolution, a short exposure process and a high frame rate. Then, the viewer can be presented with a moving picture with an even higher resolution. Alternatively, the R moving picture may also be captured through the long and short exposure processes.

In the various embodiments of the present disclosure described above, the image capturing processor is supposed to include an image capturing section. However, the image capturing processor does not always have to include the image capturing section. For example, if the image capturing section is located somewhere else, then G_{L}, G_{S}, R and B, which are results of image capturing, may be just received and processed.

Furthermore, in the various embodiments of the present disclosure described above, the image capturing processor is supposed to include an image capturing section. However, the image capturing processor does not have to include the image capturing section, the temporal addition section 103 and the spatial addition section 104.

For example, if these components are located at discrete positions, then the image quality improving section 105 may just receive and process the respective moving picture signals G_{L}, G₃, R and B, which are the results of image capturing, and output moving picture signals in respective colors (i.e., R, G and B) with increased resolutions. Alternatively, the image quality improving section 105 may receive respective moving picture signals G_{L}, G_{S}, R and B that have been either retrieved from a storage medium (not shown) or over a network. Still alternatively, the image quality improving section 105 may output the respective moving picture signals that have been processed to have their resolution increased either through video output terminals or through a network terminal such as an Ethernet™ terminal to another device over the network.

In the various embodiments of the present disclosure described above, the image capturing processor is supposed to have any of the various configurations shown in the drawings. For example, the image quality improving section 105 (see FIGS. 1 and 2) is illustrated as a functional block. Those functional blocks may be implemented either by means of hardware using a single semiconductor chip or IC such as a digital signal processor (DSP) or as a combination of a computer and software (e.g., a computer program).

The image capturing processor of the present disclosure can be used effectively to capture an image with high resolution or in small pixels when only a small amount of light is coming with the subject moving significantly. Furthermore, the processing section does not always have to be implemented as a device but may also be applicable as a program as well.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An image generator comprising:
an image quality improvement processing section configured to receive signals representing first, second, and third moving pictures, which have been obtained by shooting the same subject, and configured to generate a new moving picture representing that subject; and
an output terminal that outputs a signal representing the new moving picture,
wherein the second moving picture has a different color component from the first moving picture and each frame of the second moving picture has been obtained by performing an exposure process for a longer time than one frame period of the first moving picture, and
wherein the third moving picture has the same color component as the second moving picture and each frame of the third moving picture has been obtained by performing an exposure process for a shorter time than one frame period of the second moving picture.

2. The image generator of claim 1, wherein by using signals representing the first, second and third moving pictures, the image quality improvement processing section generates a new moving picture, of which the frame rate is equal to or higher than the frame rate of the first or third moving picture and the resolution is equal to or higher than the resolution of the second or third moving picture.

3. The image generator of claim 1, wherein the second moving picture has a higher resolution than the third moving picture, and
wherein by using signals representing the second and third moving pictures, the image quality improvement processing section generates, as one of the color components of the new moving picture, a signal representing a moving picture, of which the resolution is equal to or higher than the resolution of the second moving picture, the frame rate is equal to or higher than the frame rate of the third moving picture and the color component is the same as the color component of the second and third moving pictures.

4. The image generator of claim 3, wherein the image quality improvement processing section determines the pixel value of each frame of the new moving picture so as to reduce a difference in the pixel value of each frame between the second moving picture and the new moving picture being subjected to temporal sampling so as to have the same frame rate as the second moving picture.

5. The image generator of claim 3, wherein the image quality improvement processing section generates a moving picture signal with a color green component as one of the color components of the new moving picture.

6. The image generator of claim 3, wherein the image quality improvement processing section determines the pixel value of each frame of the new moving picture so as to reduce a difference in the pixel value of each frame between the first moving picture and the new moving picture being subjected to spatial sampling so as to have the same resolution as the first moving picture.

7. The image generator of claim 1, wherein frames of the second and third moving pictures are obtained by performing an open exposure between the frames.

8. The image generator of claim 1, wherein the image quality improvement processing section specifies a constraint, which the value of a pixel of the new moving picture to generate needs to satisfy in order ensure continuity with the values of pixels that are temporally and spatially adjacent to the former pixel, and generates the new moving picture so as to maintain the constraint specified.

9. The image generator of claim 1, further comprising a motion detecting section configured to detect the motion of an object based on at least one of the first and third moving pictures,
wherein the image quality improvement processing section generates the new moving picture so that the value of each pixel of the new moving picture to generate maintains the constraint to be satisfied based on a result of the motion detection.

10. The image generator of claim 9, wherein the motion detection section calculates the degree of reliability of the motion detection, and
wherein the image quality improvement processing section generates a new picture by applying a constraint based on a result of the motion detection to an image area, of which the degree of reliability calculated by the motion detection section is high, and by applying a predetermined constraint, other than the motion constraint, to an image area, of which the degree of reliability is low.

11. The image generator of claim 10, wherein the motion detection section detects the motion on the basis of a block, which is defined by dividing each of multiple images that form the moving picture, calculates the sum of squared differences between the pixel values of those blocks, and obtains the degree of reliability by inverting the sign of the sum of squared differences, and
wherein the image quality improvement processing section generates the new moving picture with a block, of which the degree of reliability is greater than a predetermined value, defined to be an image area with a high degree of reliability and with a block, of which the degree of reliability is smaller than the predetermined value, defined to be an image area with a low degree of reliability.

12. The image generator of claim 9, wherein the motion detection section includes an orientation sensor input section configured to receive a signal from an orientation sensor that senses the orientation of an image capture device that captures an object, and detects the motion based on the signal that has been received by the orientation sensor input section.

13. The image generator of claim 1, wherein the image quality improvement processing section extracts color difference information from the first and third moving pictures, generates an intermediate moving picture based on the second moving picture and luminance information obtained from the first and third moving pictures, and then adds the color difference information to the intermediate moving picture thus generated, thereby generating the new moving picture.

14. The image generator of claim 1, wherein the image quality improvement processing section calculates the magnitude of temporal variation of the image with respect to at least one of the first, second and third moving pictures, and
if the magnitude of variation calculated is going to exceed a predetermined value, the image quality improvement processing section stops generating the moving picture based on images that have been provided until just before the predetermined value is exceeded, and starts generating a new moving picture right after the predetermined value has been exceeded.

15. The image generator of claim 1, wherein the image quality improvement processing section further calculates a value indicating the degree of reliability of the new moving picture generated and outputs that calculated value along with the new moving picture.

16. The image generator of claim 1, further comprising an image capturing section configured to generate the first, second and third moving pictures using a single imager.

17. The image generator of claim 16, further comprising a control section configured to control the processing by the image quality improvement processing section according to a shooting environment.

18. The image generator of claim 17, wherein the image capturing section generates the second moving picture, which has a higher resolution than the third moving picture, by performing a spatial pixel addition, and
wherein the control section includes a light amount detecting section configured to detect the amount of light that has been sensed by the image capturing section, and if the amount of light that has been detected by the light amount detecting section is equal to or greater than a predetermined value, the control section changes an exposure time and/or the magnitude of the spatial pixel addition with respect to at least one of the first, second and third moving pictures.

19. The image generator of claim 18, wherein the control section includes a level detecting section configured to detect the level of a power source for the image generator, and changes an exposure time and/or the magnitude of the spatial pixel addition with respect to at least one of the first, second and third moving pictures according to the level that has been detected by the level detecting section.

20. The image generator of claim 18, wherein the control section includes a magnitude of motion detecting section configured to detect the magnitude of motion of the subject, and changes an exposure time and/or the magnitude of the spatial pixel addition with respect to at least one of the first, second and third moving pictures according to the magnitude of motion of the subject that has been detected by the magnitude of motion detecting section.

21. The image generator of claim 18, wherein the control section includes a mode of processing choosing section configured to allow the user to choose a mode of making image processing computations, and changes an exposure time and/or the magnitude of the spatial pixel addition with respect to at least one of the first, second and third moving pictures according to the mode chosen through the mode of processing choosing section.

22. The image generator of claim 1, wherein the image quality improvement processing section specifies a constraint, which the value of a pixel of the new moving picture to generate needs to satisfy in order ensure continuity with the values of pixels that are temporally and spatially adjacent to the former pixel, and
wherein the image quality improvement processing section generates the new moving picture so as to reduce a difference in the pixel value of each frame between the second moving picture and the new moving picture being subjected to temporal sampling so as to have the same frame rate as the second moving picture and so as to maintain the constraint that has been specified.

23. The image generator of claim 1, further comprising an image capturing section configured to generate the first, second and third moving pictures using three imagers.

24. An image generating method comprising the steps of:
receiving signals representing first, second, and third moving pictures, which have been obtained by shooting the same subject, the second moving picture having a different color component from the first moving picture, each frame of the second moving picture having been obtained by performing an exposure process for a longer time than one frame period of the first moving picture, the third moving picture having the same color component as the second moving picture, each frame of the third moving picture having been obtained by performing an exposure process for a shorter time than one frame period of the second moving picture;
generating a new moving picture representing that subject based on the first, second and third moving pictures; and
outputting a signal representing the new moving picture.

25. A computer program stored on a non-transitory computer-readable storage medium, the computer program being defined to generate a new moving picture based on multiple moving pictures, wherein the computer program makes a computer, which executes the computer program, perform the steps of the image generating method of claim 22.
